(19) United States
(12) Patent Application Publication
(10) Pub. No.: US 2014/0194144 A1
(43) Pub. Date: Jul. 10, 2014

(54) PROCESSING PLACE MARKERS

(71) Applicant: Rosina Jimenez Godoy, Caracas (VE)

(72) Inventor: Rosina Jimenez Godoy, Caracas (VE)

(21) Appl. No.: 13/738,350

(22) Filed: Jan. 10, 2013

(51) Int. Cl. H04W 4/02

(52) U.S. Cl. CPC H04W 4/025
USPC 455/456.2

(57) ABSTRACT

Computer-implemented systems for processing place markers at a mobile computing device. The mobile computing device may receive from a user a request to generate a first place marker for a first place corresponding to a current location of the mobile computing device and may receive an indication of the current location of the mobile computing device. Further, the mobile computer device may receive descriptive information associated with the first place and generate the first place marker. The first place marker may comprise an indication of a location of the first place and the user information associated with the first place, where the location of the place is the current location of the mobile computing device.

### BACKGROUND

The proliferation of smart phones, tablet computers and other network-enabled mobile computing devices has generated demand for applications, or “apps” that provide users with various information and/or services. Apps provide mobile computing device users with games, social networking, news alerts, travel and/or traffic-related alerts, etc. Many apps are available for download at central distribution server systems. For example, each of the current major mobile computing device platforms (APPLE I/OS and GOOGLE ANDROID) has a separate app distribution service (i.e., the APPLE APPSTORE, the ANDROID MARKET).

There is a continuing need for new mobile computing device apps. For example, there is a need for apps that allow a user to catalog locations that the user has visited and view locations cataloged by other users.

### FIGURES

Various embodiments of the present invention are described herein, by way of example, in conjunction with the following Figures wherein:

FIG. 1 is a diagram of an environment for processing place markers.

FIG. 2 is a diagram showing additional details of an example mobile computing device and the application server system of the environment of FIG. 1.

FIG. 3 is a diagram of one embodiment of a mobile computing device.

FIG. 4 is a flow chart illustrating one embodiment of a process flow that may be performed by an app executed by a mobile computing device to generate a place marker.

FIG. 4A is a flow chart illustrating one embodiment of a process flow that may be performed by an app executed by the app executed by the mobile computing device to provide a user with functionality for sharing a place marker folder.

FIG. 5 is a flow chart illustrating one embodiment of a process flow that may be performed by the app executed by the mobile computing device to provide directions to a place associated with a previously-generated place marker.

FIG. 6 is a flow chart illustrating one embodiment of a process flow that may be performed by the app executed by the mobile computing device to implement a search for place markers.

FIG. 6A is a flow chart illustrating one embodiment of a process flow that may be performed by the app executed by the mobile computing device to implement a search for place markers based on a shared folder.

FIG. 7 is a screen shot illustrating one embodiment of an interface screen that may be displayed to the user by the app, as described herein, to generate a place marker.

FIG. 8 is a screen shot illustrating one embodiment of another interface screen that may be displayed to the user by the app, as described herein, to generate a place marker.

FIG. 9 is a screen shot illustrating one embodiment of the of the interface screen of FIG. 8 comprising text describing the place.

FIGS. 10 and 11 are screen shots illustrating embodiments of an interface screen illustrating an example hierarchal organization system for organizing place markers.

FIG. 12 is a screen shot illustrating one embodiment of an alternate interface screen showing an example hierarchal organization system for organizing place markers.

FIG. 13 is a screen shot illustrating one embodiment of an interface screen that may be displayed to a user to provide functionality for searching place markers.

FIG. 14 shows several screen shots illustrating embodiments of interface screens that may be utilized to receive search parameters and display results of searches for place markers.

FIG. 15 is a screen shot illustrating one embodiment of an alternate interface screen for presenting directions to a place associated with a place marker.

FIG. 16 is a screen shot illustrating one embodiment of a social menu interface screen that may be displayed by the app.

FIG. 17 is a screen shot showing one embodiment of an interface screen that may be displayed by the app when the user selects, the Activity button of FIG. 16.

FIG. 18 is a screen shot illustrating one embodiment of an interface screen that may be displayed by the app when the user selects the Explore button of FIG. 16.

FIG. 19 is a screen shot illustrating one embodiment of an interface screen that may be displayed by the app when the user selects the news button of FIG. 16 and a Following button.

FIG. 20 is a screen shot illustrating one embodiment of an interface screen that may be displayed by the app when the user selects the News button of FIG. 16 and a additional News button.

FIG. 21 is a screen shot illustrating one embodiment of an interface screen that may be displayed by the app when the user selects the Profile button.

FIG. 22 is a screen shot showing one embodiment of an additional interface screen that may be displayed by the app when the user selects the Profile button.

FIG. 22A is a screen shot illustrating one embodiment of an interface screen that may be displayed to the user by the app to provide functionality for generating, searching, and viewing place markers.

FIG. 23 is a system diagram of one embodiment of an example architecture for a mobile computing device.

FIG. 24 is a system diagram of another embodiment of an example architecture for a mobile computing device. and

FIG. 25 is a diagram of one embodiment of an example operating system.

### DESCRIPTION

Various embodiments of the present inventions described herein are directed to smart phone (or other mobile computing device) apps that provide functionality for processing place markers. Place markers are data describing a particular geographic location (e.g., a place) and associated descriptive information (e.g., information associated with the place). The descriptive information may be any data or information that may be associated with a place. For example, the descriptive information may describe concepts associated with the place by an individual user of the app and/or by the public at large. In various embodiments, the descriptive information comprises descriptions of the place, descriptions of things present at the place (e.g., businesses, products, buildings, monuments, etc.), as well as descriptions of intangible things such as memories, thoughts, or ideas associated with the place by the user. In commercial use, place markers can be referred to by any suitable name including, for example, DOTS.

Various embodiments of the apps described herein include functionality for generating place markers. An app may execute on a mobile computing device operated by a user. The user may be a consumer or end user of the app. Generally, the app may receive from the user a request to generate a place marker, along with descriptive information associated with the place. The app may combine the descriptive information with an indication of the physical location of the place to generate a place marker. The physical location of the place may be determined in any suitable manner. In some embodiments, the physical location of the place is provided by the user as an input to the app. Also, in some embodiments, the place is set equal to a current location of the mobile computing device. For example, the app may query a positioning module or functionality of the mobile computing device to determine its current location. The descriptive information may include any suitable information received in any suitable form. For example, the information may comprise an image. The image may be an image of all or a portion of the place, an image of an object present at the place, or an unrelated image. In some embodiments, the user may be prompted by the app to capture the image at or near the time that the place marker is generated using a camera of the mobile computing device.

Upon generation, place markers may be stored locally at the mobile computing device or remotely, for example, at one or more application servers. In some embodiments, place markers are stored at data storage of the mobile computing device according to an organization or folder structure determined, at least in part, by the user. Additionally, in some embodiments, place markers may be shared with other users. The user may determine whether to share place markers with other users. If a place marker is to be shared with other users, the mobile computing device may transmit the place markers to the application server. Place markers stored at the application server may be accessible to other users. In some embodiments, a user may determine to share a place marker or markers only with a selected group of users. An indication of the group may be provided to the application server. In some embodiments, place markers may be shared by folder. A user may designate one or more place markers as belonging to a specific folder. The folder may be shared such that all or a selected group of other users can view the folder. In some embodiments, the other users may view the folder, but may not access place markers in the folder without authorization of the sharing user.

In some embodiments, apps described herein comprise functionality for searching place markers. Searches may be performed on a database of place markers according to any suitable search parameters. The database of place markers may comprise a local storage of the mobile computing device and/or one or more remote data storage locations (e.g., data storage associated with the application server described above). Searches may be structured in any suitable manner. In some embodiments, the user is provided with an interface graphically illustrating a searchable organization structure for stored place markers. In some embodiments, the user provides search parameters (e.g., key words or other place marker characteristics) that are used in the search. In some embodiments, the user selects a start point corresponding to a physical location. The app may return place markers having places that are within a threshold distance from the start point. In some embodiments, the returned place markers are provided to the user in order based on their physical distance from the start point. In some embodiments, the app may return a list of folders that are accessible to the user (e.g., folders created by other users). If the user desires to view place markers in a specific folder, the user may query the user sharing the specific folder for permission.

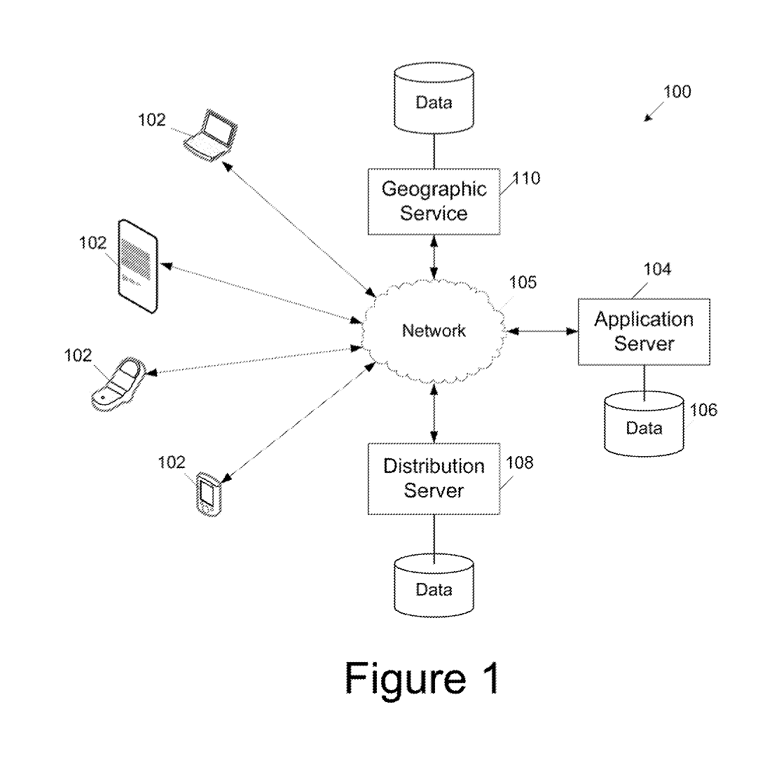

Before describing the apps introduced above in additional detail, this disclosure first briefly describes some details about suitable mobile computing environments and devices that can use the apps. FIG. 1 is a diagram of an environment 100 for processing place markers. The environment 100 comprises the mobile computing devices 102 as well as various server systems 104, 108, 110. The various devices and systems 102, 104, 108, 110 may be in communication with one another via a data network 105. The data network 105 may comprise any suitable type of wired and/or wireless network and, in some embodiments, may comprise the Internet. For example, the mobile computing devices 102 may connect to the network 105 utilizing a mobile telecommunications network, a local area network (LAN), a wired connection utilizing a universal serial bus (USB) or other communications port of the mobile computing device 102, etc. The data network 105 may also be and/or comprise all or a portion of a mobile telecommunications network such as, for example, a 3G, 4G or other suitable network.

The mobile computing devices 102 may execute applications or apps that configure the mobile computing devices 102 to generate, search, share and/or perform other processing of place markers, as described herein. The application server system 104 may take various forms and may provide various data and/or services to the mobile computing devices 102. For example, the application server system 104 may be a single computer device or server. In some embodiments, the application server system 104 comprises multiple computer devices or servers that may be at multiple geographic locations. In some embodiments, the application server system 104 is implemented in a networked manner such as, for example, according to a cloud computing or software as a service (SaaS) model. The application server system 104 may provide various services to the mobile computing devices 102, including during the execution of some apps. Such services may include data and/or processing services to facilitate execution of the app or apps. For example, and as described in more detail below, the application server system 104 may receive place markers to be shared among users and may respond to place marker queries from apps executing on various mobile computing devices 102. Some embodiments of the apps described herein operate independent of an application server system 104. For example, place markers may be stored and searched locally.

In some embodiments, the application server system 104 may also provide the mobile computing devices with executables and/or other resources for implementing various apps. Alternately, some or all executables and/or other app resources may be downloaded from a distinct app distribution server system 108, which may comprise one or more servers or other computer devices and, like the application server system 104, may be implemented in a cloud or networked manner. Example distribution services include the APPLE i/OS APP STORE, the ANDROID MARKET, etc. The environment 100 also comprises a geographic service server 110 and associated database. The geographic service server 110, as described herein, may provide various mapping and direction services to mobile computing devices 102 and/or the application server 104. For example, the geographic service server 110 may provide directions to and/or maps of places associated with place markers. Example geographic service servers may include, for example, GOOGLE MAPS, BING MAPS, etc. In some embodiments, the functionality of the geographic service server may be performed by an additional app (e.g., a GPS app) executed by the mobile computing device 102, the application server 104, etc.

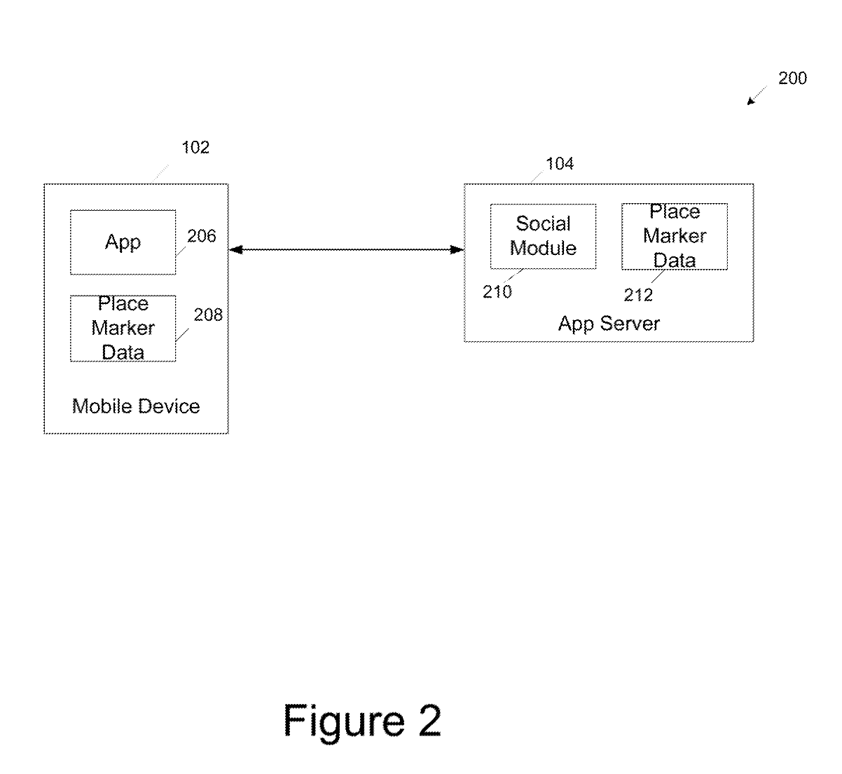

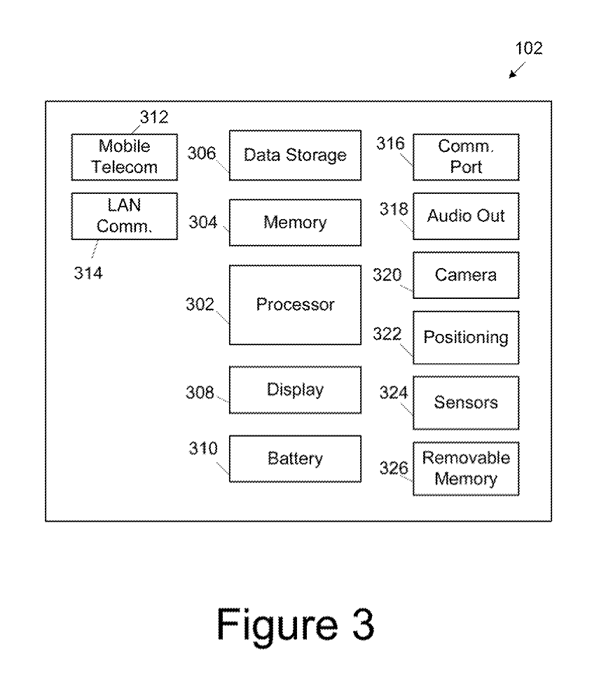

FIG. 2 is a diagram 200 showing additional details of an example mobile computing device 102 and the application server system 104 of the environment 100. The mobile computing device 102 may comprise an app 206. The app 206 may be stored at any suitable data storage location of the mobile computing device including, for example, data storage 306, memory 304, removable memory 326, etc., described in more detail below with respect to FIG. 3. In various embodiments, the app 206 may be executed by a processor or processors 306 of the mobile computing device 102, again, as described below with respect to FIG. 3. Although one app 206 is shown, it will be appreciated that implementing the functionality described herein may sometimes involve executing multiple apps. Resources for executing the app 206 (e.g., executables, data, etc.) may be downloaded to the mobile computing device 102 from the application server system 104 and/or from a separate distribution server system such as the app distribution server system 108 described herein above. The mobile computing device 102 may also comprise various other resources for executing the app 206. Such resources may also be stored at any suitable data storage location or locations as described above. For example, the mobile computing device 102 may comprise place marker data 208 describing place markers that have been previously generated and/or received by the mobile computing device 102. Although only one mobile computing device 102 is shown in FIG. 2, it will be appreciated that some or all of the mobile computing devices 102 of the environment 100 may be configured as illustrated in FIG. 2.

The application server system 104 may execute one or more software modules for processing place markers. A social module 210 may receive from various mobile computing devices 102 place markers to be shared and, in some embodiments, parameters for sharing the place markers (e.g., a group of users that are authorized to view a place marker or folder). The social module 210 may also respond to place marker queries from mobile computing devices 102. In some embodiments, the social module 210 implements the parameters for sharing the place markers. For example, when a place marker query is received from a mobile computing device 102 associated with a particular user, the social module 210 may return only place markers that the user is authorized to access and/or place marker folders that the user is authorized to view. The application server 104 may also comprise place marker data 212 (e.g., stored at data storage 106). The place marker data 212 may comprise place markers that have been generated by the users and/or outside parties to be shared with other users.

Before providing additional details of systems and methods for processing place markers, a detailed description is provided of example hardware and software architectures for mobile computing devices 102 that may be utilized. The mobile computing devices 102 may include any type of mobile computer or computer device capable of executing an app. Examples of mobile computing devices may include Internet-enabled mobile telephones, smart phones (e.g., APPLE IPHONE, ANDROID-based smart phones, BLACKBERRY smart phones, etc.), tablet computers, laptop computers, etc. Mobile computing devices 102 typically provide a rich set of hardware and other features that may be utilized by apps, including the app 206 for processing place markers. For example, FIG. 3 is a diagram of one embodiment of a mobile computing device 102. The device 102 comprises a processor 302, memory 304, non-volatile data storage 306, and a display 308. The processor 302 may be any suitable type of microprocessor. In some embodiments, the processor 302 may comprise two separate processors, with one processor managing application and/or app execution and another managing communications.

The memory 304 may be random access memory and may comprise any suitable memory technology. Non-volatile data storage 306 may be any suitable type of physical disk, flash memory, etc. capable of storing data when the device 102 is powered down. In some embodiments, memory and non-volatile storage may be implemented at a common component. The display 308 may be in communication with the processor 302 to allow the processor 302 to provide a user interface to a user of the device 102. The user interface may be utilized to interact with the user during the processing of place markers, for example, as described herein. In some embodiments, the display 308 may be a tactile input or touch screen, allowing the user to provide input to the device 102 by contacting the display 308. Alternatively (or additionally) the mobile computing device 102 may comprise a track-ball (not shown) or other suitable pointing mechanism. In various embodiments, the device 102 may be powered by a battery 310, which may be any suitable type of battery including, for example, a lithium ion (Li-Ion) battery.

The device 102 may comprise a variety of additional hardware and/or software modules, described below, that may be made available to and/or utilized by apps, or may be a part of app-independent native functionality of the device 102. A mobile telecommunications interface module 312 may allow the device 102 to utilize one or more mobile communications networks (e.g., cellular networks) according to any suitable communications technology (e.g., 3G, 4G, etc.). For example, the device 102 may utilize a mobile communications network for voice and/or data communications. In some embodiments and in some circumstances, the mobile computing device 102 may be in communication with the application server system 104 via the mobile communications network (e.g., the network 105 may comprise the mobile communications network). The mobile telecommunications network may also provide the device 102 with location information, for example, derived from triangulation. That location information may be used, for example, to process place markers, as described herein. A local area network (LAN) communications interface 314 may provide a communication link between the device 102 and a LAN. The communication link may be a wired or wireless link. For example, in some embodiments, the LAN communication interface 314 may be configured to facilitate communications according to the WI-FI standard. In some embodiments and in some circumstances, the LAN communications interface 314 may be utilized to communicate with the application server system 104 (e.g., the network 105 may comprise the LAN).

A communications port 316 facilitates direct, wired communications between the mobile computing device 102 and other devices (e.g., other mobile computing devices 102, desktop or laptop computers, servers, etc.). The communications port 316 may be configured according to any suitable standard including, for example, Universal Serial Bus (USB), IEEE 1394 (FIREWIRE), etc. In addition, some mobile computing devices 102 may have an audio output module 318. The audio output module 318 may comprise hardware and/or software for providing electrical audio signals to a speaker and/or headphone set of the user. For example, the audio output module 318 may comprise an output jack for receiving an input connector of a speaker or headphone set. In some embodiments, the audio output module 318 is in electrical communication with an onboard speaker of the device 102. Also, in some embodiments, the audio output module 318 implements a digital to audio converter and/or one or more codecs for decoding audio according to various formats (.wav, .mp3, etc.). The codecs may be hardware and/or software implemented. A camera module 320 may comprise hardware and/or software for capturing images. For example, the camera module 320 may comprise a charge coupled device (CCD) or any other suitable sensor, focusing optics, as well as hardware and/or software for capturing images according to an image format (e.g., .jpg, .bmp, .tif, etc.). Captured images may be provided to the processor 302, which may store the images at memory 304 and/or data storage 306.

A positioning module 322 may comprise hardware and/or software for determining a geographic position of the device 102. For example, the positioning module 322 may comprise a satellite-based Global Positioning System (GPS) and/or any other any other type of positioning system (e.g., compass, network triangulation system, etc.). The geographic position or location of the device may be used for generating and searching for place markers, as described herein. A sensor module 324 may comprise one or more sensors that may be accessible to apps executed by the device 102. For example, the sensors may include one or more accelerometers, gyroscopes, magnetic sensors, etc. A removable memory module 326 may operate to receive one or more removable memory devices such as, for example, any form of SD card, USB flash memory, etc. It will be appreciated that different styles and/or models of mobile computing devices may have different hardware and/or software functionality. Accordingly, many mobile computing devices will include combinations of hardware/software modules different than that of the example device 102. For example, mobile computing devices may include additional hardware/software modules not shown in FIG. 3 and/or omit one or more of the hardware/software modules shown in FIG. 3.

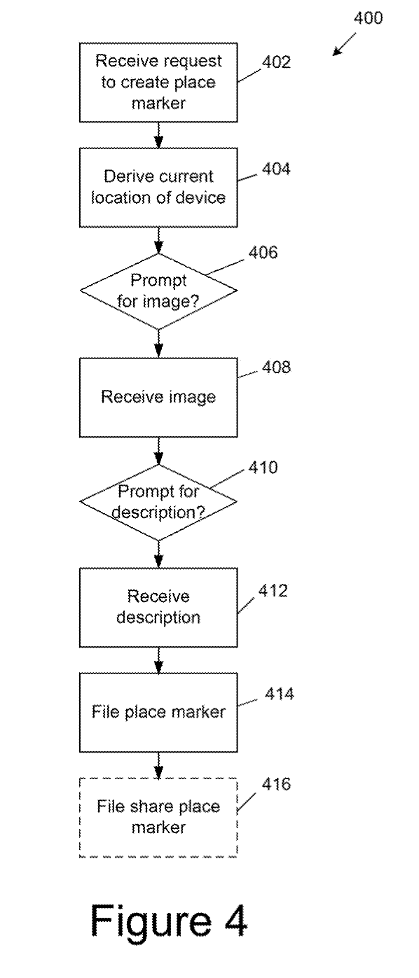

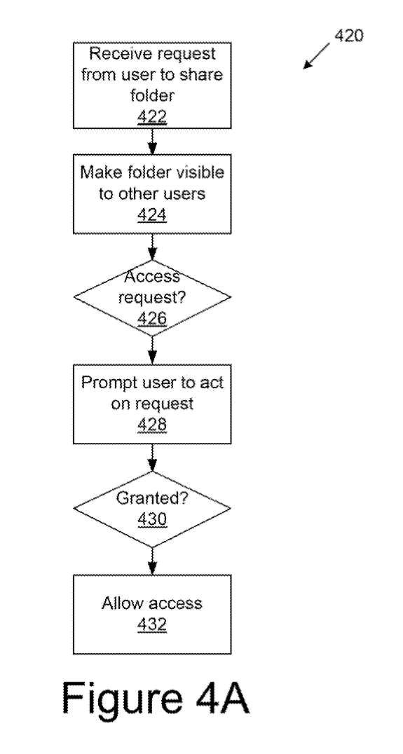

FIG. 4 is a flow chart illustrating one embodiment of a process flow 400 that may be performed by the app 206 executed by a mobile computing device 102 to generate a place marker. At 402, the app 206 may receive a request to generate a place marker. In various embodiments, the request may relate to a current location of the mobile computing device 102. For example, the user may indicate that the place marker is to be created with a place corresponding to the current location of the mobile computing device 102. Accordingly, at 404, the app 206 may derive a current location of the mobile computing device 102. In some embodiments, deriving the current location of the mobile computing device 102 may comprise querying the positioning module 322 of the mobile computing device 102. The current location may be expressed in any suitable form including, for example, as a latitude and longitude, a closest street address, etc. In some embodiments, the user may be prompted to provide a description of a place for the place marker, for example, the place marker may be created with a place other than the current location of the mobile computing device. The description may be expressed in any suitable form including, for example, as a latitude and longitude, a closest street address, etc.

Upon receiving the indication of the place, either from the user or by deriving the current location of the device at 404, the app 206 may prompt the user for descriptive information to be associated with the place by the place marker. For example, at 406, the app 206 may prompt the user for a photograph or other image to be associated with the place. If the user indicates that an image is to be included in the place marker, the app 206 may receive the image at 408. The image may be received in any suitable manner. In some embodiments, the image may be captured by the camera 320 of the mobile computing device 102 at or near the time that the place marker is created. For example, the user may take a picture of the current location of all or part of the current location of the mobile computing device. The resulting picture may be the image received at 408. For example, the app 206 may receive the image directly from the camera 320. In some embodiments, the image may be an alternate image provided by the user (e.g., an image captured previously, an image received from another source, etc.).

At 410, the app 206 may prompt the user for a description of the place. If a description is to be provided, the app 206 may receive the description at 412. The description may comprise text received from the user (e.g., via an interface). The text may be any text determined by the user. For example, the text may comprise a description of the place and/or a description of the concept associated with the place. In one example embodiment, the place is a store and the text describes an item for sale at the store. In various embodiments, any other type of information may be received by the app 206 to be associated with the place in the place marker. Examples of such information may include, for example, sounds, video clips, other multimedia, etc.

At 414, the app 206 may file the generated place marker at the mobile computing device 102 (e.g., at a data storage 306 of the mobile computing device 102) and/or remotely at the app server 104. For example, the user may specify a logical position of the place marker within an organization system. The organization system may comprise one or more hierarchically-arranged folders. In various embodiments, some or all of the folders correspond to hierarchically-arranged categories. The user may be prompted to select and/or create one or more folders for placement of the place marker. Optionally, at 416, the app 206 may share the place marker. In some embodiments, user approval is received before a place marker is shared. User approval may be expressed as an approval to share all place markers or all place markers of a given folder (e.g., as part of account information received from the user as described herein below). In some embodiments, user approval may be expressed as an approval to share viewing privileged for a folder comprising place markers, as described herein. Also, in some embodiments, user approval may be provided on a place marker-by-place marker basis. Place markers may be shared with all users and/or with a group of users. The group of users may be expressed in any suitable way. For example, the group of users may be expressed as a classification of users (e.g., users having certain characteristics, users that have been approved by the first user to follow place markers generated by the first users, users that have been approved by the first user to follow all or a category of place markers generated by the first user, etc.). The group of users may also be expressed as indications of particular users that are or are not permitted to access the place marker. For example, if a place marker is associated with the place where a first user proposed marriage to a second user, the first user may choose to share the place marker with the second user only. If a place marker is to be shared, it may be transmitted to the app server 104 (e.g., the social module 210 thereof). In various embodiments, the place marker is transmitted to the app server 104 with permissions data indicating the subset of all users with which the place marker may be shared.

Once generated, place markers may be retrieved by the app 206 in any suitable manner. In some embodiments, the app 206 provides the user with an interface showing previously generated place markers. The place markers may be displayed according to the organization system described above. The place markers displayed may be stored locally and/or may include place markers stored at a remote location (e.g., received through the social module 210 of the app server 104). Place markers received from the social module 210 may include place markers generated by other users that have been shared with permissions that allow access to the user. In some embodiments, place markers received from the social module 210 may also include commercial placement markers generated for advertisers. For example, a commercial placement marker may be associated with a place or places of business. Information describing the place or places of business may describe the type of goods and/or service provided by the business, a place marker-associated discount on goods and/or services provided by the business, etc. The user may select a place marker for viewing. When a place marker is viewed, the app 206 may provide an interface showing the image, text or other information that is associated with the place and, in some embodiments, a map or other geographic indication showing the location of the place. In some embodiments, the map or other geographic indication may be received from the geographic service server 110.

FIG. 4A is a flow chart illustrating one embodiment of a process flow 420 that may be performed by an app executed by the app 206 executed by the mobile computing device 102 to provide a user with functionality for sharing a place marker folder. Place marker folders or folders, as described above with respect to 414, may comprise one or more place markers and may be organized by category. For example, the sharing user may create folders and/or file place markers in folders based on a category or other descriptive information about the place marker. At 422, the app may receive a request from the sharing user to share a folder. The request may specify the folder and sharing parameters. Sharing parameters may include, for example, an indication of another user or users who are authorized to access the folder, and a type of access. Users authorized to access the folder may include all other users, or a subset of other users indicated by the sharing user. For example, a user may create a folder of restaurants that his or her family frequents and allow access to a group of users including other members of the family. The type of access may indicate how the other users are allowed to access the place markers. For example, the sharing user may indicate that some or all of the other users may view the title of the folder, but must request specific permission to access any place markers stored in the folder. This type of access may be referred to as semi-public access. In some embodiments, some or all other users may be granted access to view place markers in a folder without requesting specific permission. This type of access may be referred to as public. If the user wants the folder to remain private, he or she may refrain from making a request to share the folder. In some embodiments, the app 206 may prompt the user for a folder type (e.g., public, semi-public, or private) at the time that a folder is created.

At 424, the app 206 may make the shared folder visible to other users (e.g., all or a subset of the other users). For example, when the folder is stored at a remote location, such as the app server 104, the app 206 may send a communication to the remote location indicating the type of sharing that is to occur. A second user may view the shared folder and request access to the place marker or markers stored therein. The access request may be directed, for example, from an example of the app 206 running on the second user's mobile computing device 102 either directly to the app 206 running on the sharing user's mobile computer device 102 and/or via the app server 104. Upon receipt of the request, the app 206 may prompt the sharing user, at 428, to act on the request for the second user. If the sharing user grants the request at 430, then the app 206 may allow the second user to access place markers stored in the shared folder at 432. For example, the app 206 may direct a message to the app server 104 granting the second user the desired access. In some embodiments, interactions between the sharing user and the second user may be conducted via e-mail and/or via a social media site, such as FACEBOOK. For example, the second user may request access to the shared folder by directing an e-mail to the first user and/or to the app server 104. In some embodiments, the app 206 is configured to sync with the first user's e-mail to retrieve and respond to the request as indicated at 428, 430 and 432. Also, for example, the second user may request access to the shared folder via a message transmitted to the app server 104 and/or the app 206 via a social media site. The app 206 may be configured to synch with the social media site to retrieve and respond to the request, again as indicated at 428, 430 and 432.

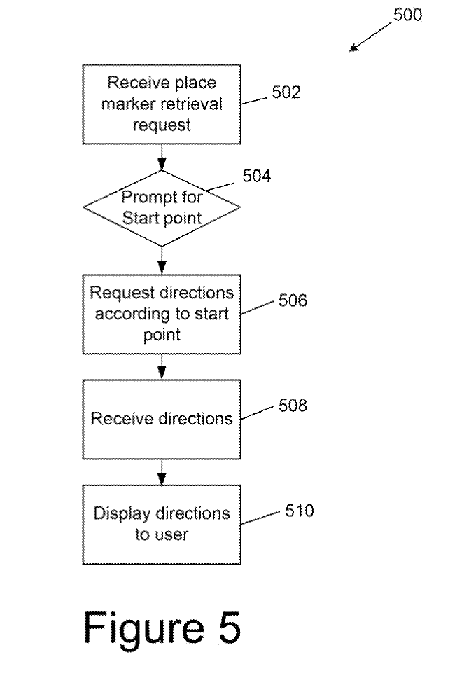

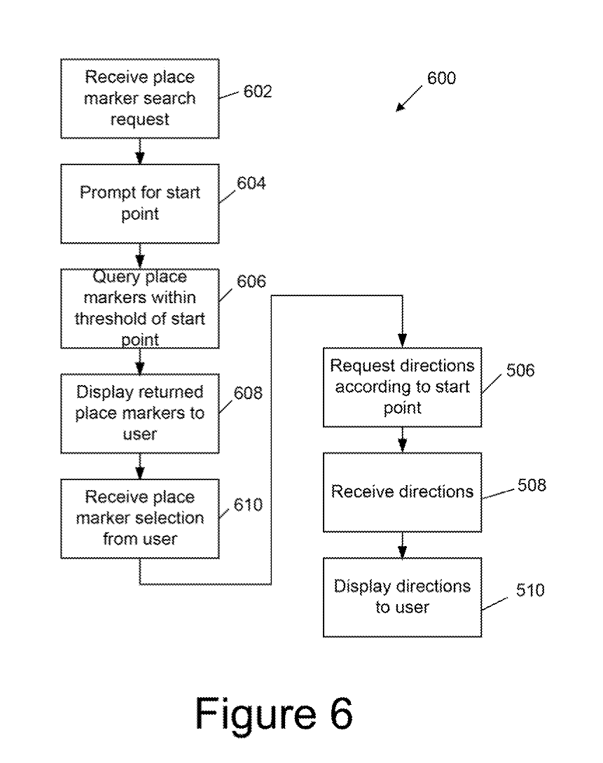

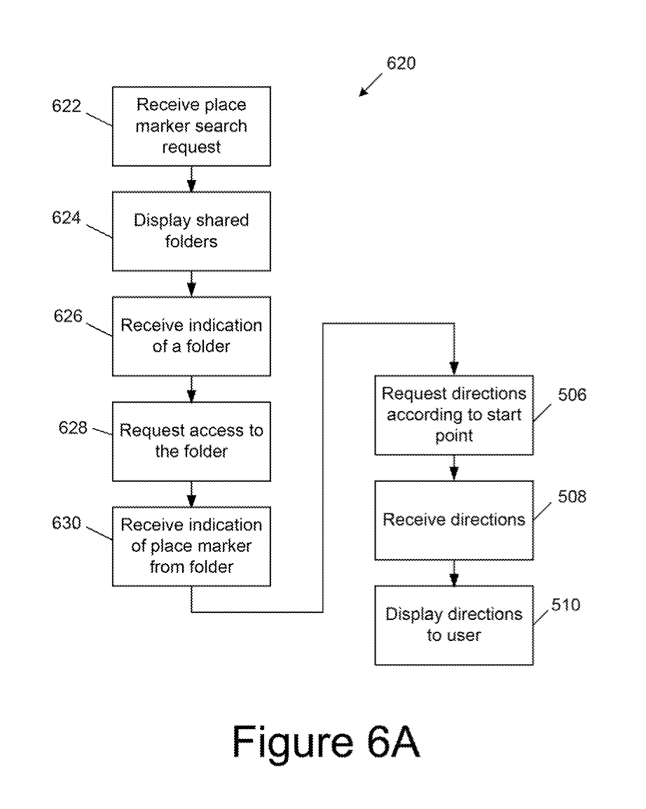

In some embodiments, place markers may be provided to users along with directions allowing the user to reach the associated place. FIG. 5 is a flow chart illustrating one embodiment of a process flow 500 that may be performed by the app 206 executed by the mobile computing device 102 to provide directions to a place associated with a previously-generated place marker. The previously-generated place marker may have been generated by the user or shared from another source. At 502, the app 206 may receive a request from the user to retrieve a place marker. The request may specify a particular place marker or, as described below, may be a request to search available place markers present either locally at the mobile computing device 102 or remotely at the app server 104. When a search is requested, the app 206 may perform a search of available place markers with parameters received from the user. Results of the search may be displayed to the user (e.g., via a graphical interface). The user may select a place marker from the results. Example methods for executing a place marker searches are provided below with respect to FIGS. 6 and 6A.

At 504, the app 206 may prompt the user for a start point. The start point may indicate a physical location from which the user would like directions to begin. The user may indicate that the start point is to be the user's current location (e.g., a current location of the mobile computing device 102). In such cases, the app 206 may determine the current location of the mobile computing device 102 (e.g., via the positioning module 322 of the device 102). In some embodiments, the user also has the option to input a location as a start point. The inputted location may be expressed, for example, as an address, a location of a train or other transportation station, a bus stop, etc. At 506, the app 206 may request directions to the place associated with the selected place marker from the start point. For example, the directions may be requested from the geographic service server 110. The directions may be received at 508 and displayed to the user at 510, for example, according to a graphical interface.

FIG. 6 is a flow chart illustrating one embodiment of a process flow 600 that may be performed by the app 206 executed by the mobile computing device 102 to implement a search for place markers. At 602, the app 206 may receive a place marker search request. In some embodiments, the place marker search request may comprise parameters describing place markers to be returned by the search. The parameters may be geographical (e.g., place markers within a threshold distance) and/or descriptive (e.g., place markers describing businesses, place markers describing restaurants, place markers describing monuments or museums, etc.). At 604, the app 206 may prompt the user to provide a start point. The start point may be used for searches based on threshold distances and/or for displaying directions to the place, as described above. The start point may be received from the user in any suitable way. For example, a map may be displayed to a user. The user may select a location from the map to be the start point. Also, for example, the user may be prompted to select a start point from a pre-populated list of categories. The categories may comprise, the user's current location (e.g., the current location of the mobile computing device 102), a particular address to be entered by the user, a transportation station or bus-stop to be entered by the user, etc. In embodiments where the user's current location is selected, the app 206 may determine the current location of the mobile computing device 102, for example, via the positioning module 322.

At 606, the app 206 may initiate a query of a place marker database for place markers (e.g., place markers within a threshold distance form the start point). The threshold distance may be received from the user and/or predefined (e.g., hard coded and/or received from the app server 104). In cases where additional search parameters are provided, these may be considered in the search as well. The place marker database may comprise multiple place markers that are available to the user. For example, the place marker database may comprise internal data storage of the mobile computing device 102 including, for example, data storage 306 and/or memory 304. For example, querying the place marker database may comprise querying the internal data storage. The internal data storage may comprise place markers that were created by the user and/or shared place markers that were previously downloaded from the app server 104. In some embodiments, the place marker database may also comprise shared place markers and/or commercial place markers stored at the app server 104. For example, querying the place marker database may comprise querying the app server 104. Place markers stored at the app server 104 may include, for example, place markers shared by other users that the user is permitted to access, commercial place markers meeting the user's search parameters and/or otherwise targeted to the user, etc.

In some embodiments, additional search parameters may be added by the user, the app 206 and/or the app server 104 based on social media considerations. For example, the user may specifically subscribe to or follow the place markers of another user. In some embodiments, the additional search parameters may be configured to return shared place markers generated by another user to whom the user subscribes or follows. Also, in some embodiments, users viewing place markers (e.g., as search results) may be provided with an interface for indicating an interest in a place marker and, in some embodiments, for disliking or indicating disapproval of a place marker. For example, a user may indicate whether they “want to go” to the place associated with the place marker. The number of likes and/or dislikes that a particular place marker has received may indicate its favorability. The favorability of a place marker may be considered as an additional search parameter. For example, the search may only return place markers having a favorability above, below or within a given range. Additionally, it will be appreciated that in some embodiments, 604 may be omitted and the query at 606 may omit the start point as a search parameter. Instead, the search may be based on the additional parameters, including the examples provided herein.

At 608, the app 206 may display to the user place markers returned as a result of the search. The user may select a place marker, which is received by the app 206 at 610. Once the place marker is received, the app 206 may provide directions to the place associated with the selected place marker as described herein above with respect to 506, 508, 510. In embodiments where 604 is omitted, the app 206 may prompt the user for a start point prior to requesting directions to the place at 506.

FIG. 6A is a flow chart illustrating one embodiment of a process flow 620 that may be performed by the app 206 executed by the mobile computing device 102 to implement a search for place markers based on a shared folder. At 622, the app 206 may receive a place marker search request. In response, the app 206 may display to the user a list of shared folders at 624. The shared folders may include, for example, folder shared by other users that are visible to the user, but do not provide the user with access to place markers stored therein. At 626, the app 206 may receive from the user an indication of a desired folder. In response, the app 206 may generate a request to access the folder. The request may be sent to the app server 104 and/or to another instance of the app 206 executing on a mobile computing device 102 associated with the sharing user. If the sharing user authorizes, the app 206 may receive and provide to the user an indication of one or more place markers stored in the folder. The app 206 may receive from the user an indication of a place marker selected from the one or more place markers at 630. Once the place marker is received, the app 206 may provide directions to the place associated with the selected place marker as described herein above with respect to 506, 508, 510.

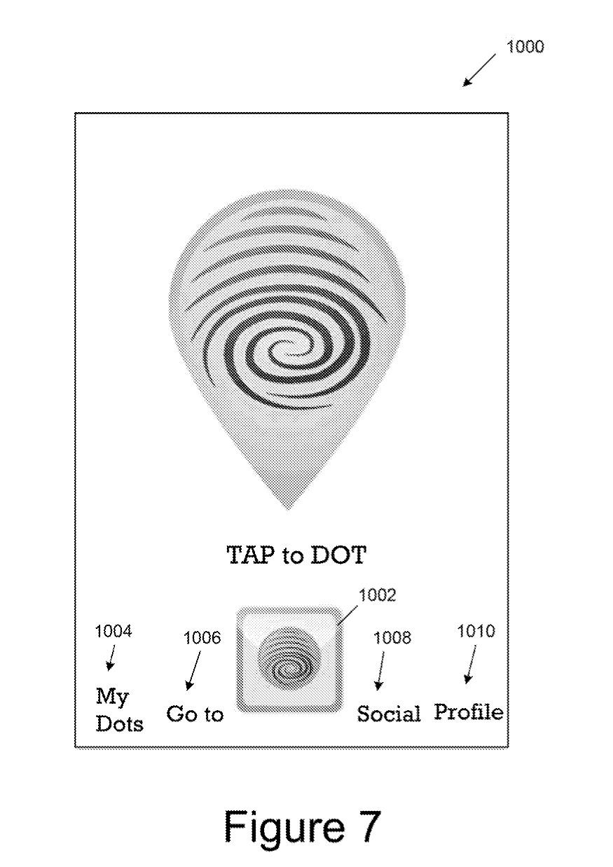

FIG. 7 is a screen shot illustrating one embodiment of an interface screen 1000 that may be displayed to the user by the app 206, as described herein, to generate a place marker. The screen 1000 comprises a button 1002 that may be selected to begin generating a place marker (e.g., as described herein above with respect to FIG. 4). My Dots (1004), Go to (1006), Social (1008) and Profile (1010) buttons may provide other functionality, as described herein starting with FIG. 16. For example, the My Dots button 1004 may correspond to the Activity button 1082. The Go to button 1006 may correspond to the Explore button 1084, the Social button 1008 may correspond to the News button 1086 and the Profile button 1010 may correspond to the Profile button 1088.

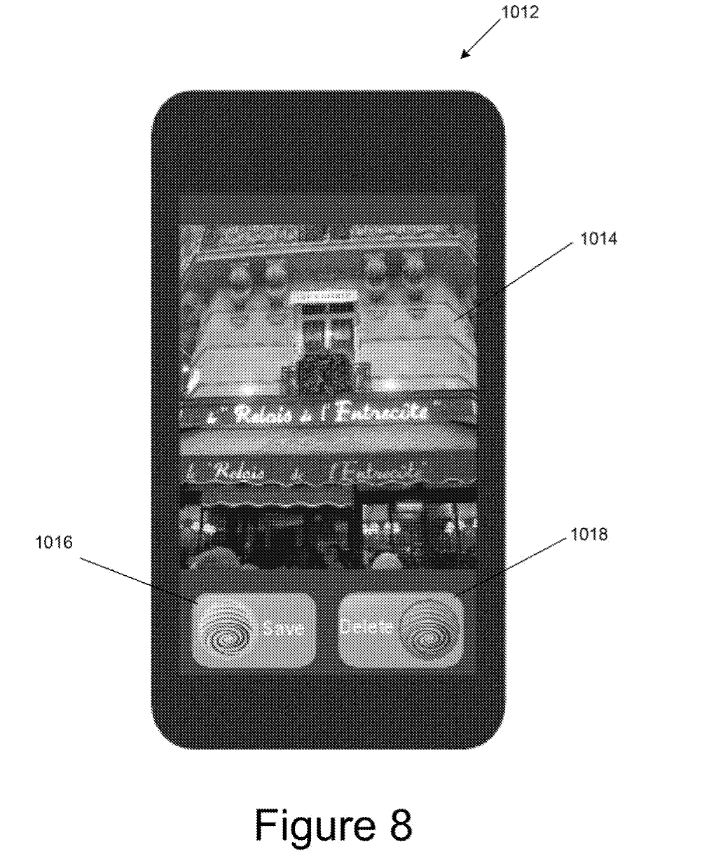

FIG. 8 is a screen shot illustrating one embodiment of another interface screen 1012 that may be displayed to the user by the app 206, as described herein, to generate a place marker. The screen 1012 as configured in FIG. 8 may be displayed to the user, for example, after the app 206 has received an image (e.g., 408 above). The image may be displayed at an image field 1014 of the screen 1012. In the example shown in FIG. 8, the place is a restaurant, and the image shown at field 1014 is a photograph of the entrance of the restaurant (e.g., a photograph taken with the camera 320 of the mobile computing device 102). Screen 1012 also comprises Save (1016) and Delete (1018) buttons. The user may select the Save button 1016 to save the place marker, as described herein. The place marker may be deleted by selecting the Delete button 1018.

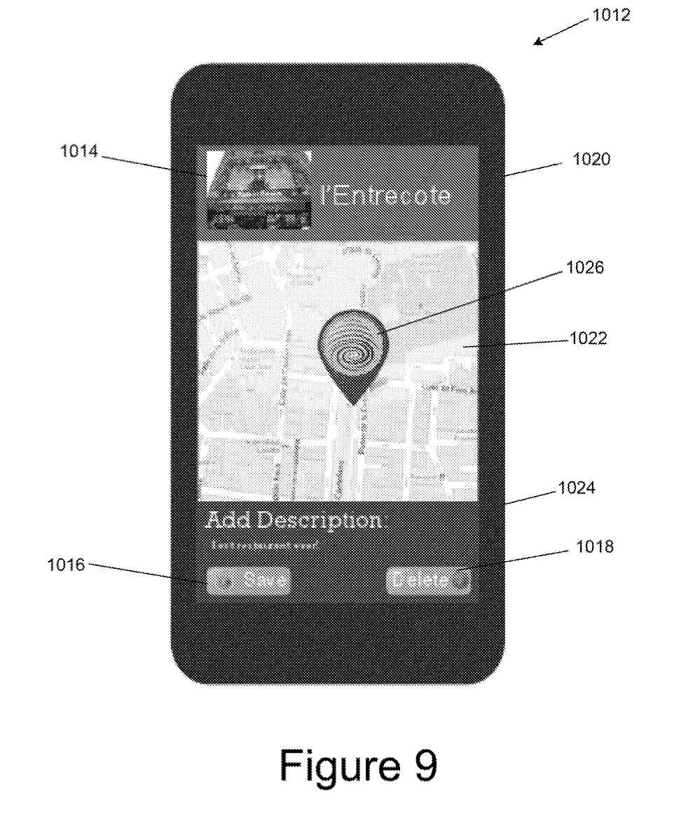

FIG. 9 is a screen shot illustrating one embodiment of the of the interface screen 1012 of FIG. 8 comprising text describing the place. The screen 1012 comprises an “Add Description” button or field 1024. The user may enter text directly into the field 1024. In some embodiments, the user selects the field 1024 to be shown a data entry interface (not shown) for receiving the text. Display of the “Add Description” button 1024 may correspond to action 410 of the process flow 400 described above. The screen 1012 also comprises a text field 1020. The text field 1020 may include all or part of the text describing the place entered, for example, utilizing the “Add Description” button 1024. The screen 1012, as illustrated in FIG. 9, also includes a map field 1022. The map field 1022 comprises an icon 1026 corresponding to the physical location of the place of the illustrated place marker. The app 206 may be programmed to request the map shown in the map field 1022 from the geographic service server 110 and/or from a GPS or other map functionality internal to the mobile computing device 102 (e.g., another app executing on the device 102). The screen 1012 shown in FIGS. 8 and 9 may be shown to the user during the creation of a place marker, as described. In some embodiments, however, the screen 1012 may also be shown to the user to allow the user to view a previously generated place marker, for example, in response to a search of place markers.

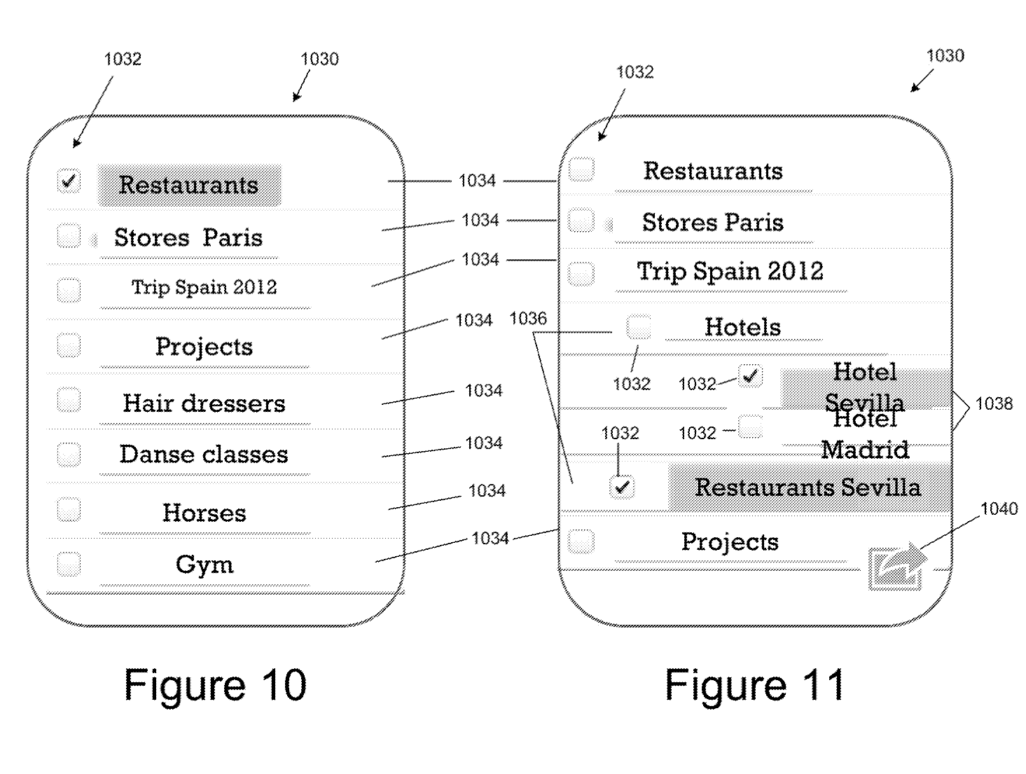

FIGS. 10 and 11 are screen shots illustrating embodiments of an interface screen 1030 illustrating an example hierarchal organization system for organizing place markers, for example, as described herein above. As illustrated in FIG. 10, the screen 1030 lists a plurality of folders 1034. Each folder may comprise one or more place markers. For example, the place markers stored in any given folder may be of a common category or type. Place markers may be organized into folders in any suitable manner. For example, the user creating a place marker may assign it to a folder at the time of creation. After creation, the place marker may be moved to a different folder, either by the creating user or by a user with whom the place marker has been shared. The folders 1034 themselves may be determined by individual users of the app 206. In some embodiments, individually generated folders may be uploaded by the app 206 to the app server 104 where they may be shared with other users. As illustrated in FIG. 10, each of the folders 1034 comprises a corresponding selection field 1032. The user may check the selection field to select a folder.

In FIG. 11, the user has selected the folder 1034 “Trip Spain 2012” to illustrate hierarchally arranged sub-folders 1036 (e.g., “Hotels” and “Restaurants Sevilla”). The “Hotels” sub-folder 1036 is further expanded to list place markers 1038 (e.g., Hotel Sevilla, Hotel Madrid). In some embodiments, the user may need to request permission before being allowed to view the place markers 1038 as described herein with respect to FIGS. 4A and 6A. Although the organization system shown in FIGS. 10-11 includes two levels of hierarchal folders (1034, 1036) before reaching place markers 1038, it will be appreciated that any suitable number of hierarchal levels may be used, for example, at the configuration of the user. The user may be provided with a return button 1040 allowing the user to return to the previous configuration of the screen 1030 (e.g., the configuration shown in FIG. 10).

In some embodiments, the user selects one of the place markers 1038. When a place marker 1038 is selected, the app 206 may display to the user an interface describing the selected place marker. An example of such an interface is described above with respect to FIGS. 8 and 9. For example, the app 206 may, through the screen 1012 shown at FIGS. 8 and 9, provide the user with functionality for modifying aspects of the place marker (e.g., providing an additional or replacement image, providing additional or replacement text, etc.). Referring specifically to the screen 1012, the app 206 may be configured to provide the user with directions to the place associated with the selected place marker 1038. For example, the app 206 may be configured to provide directions, as described herein, when the user selects the map field 1022 and/or the icon 1026.

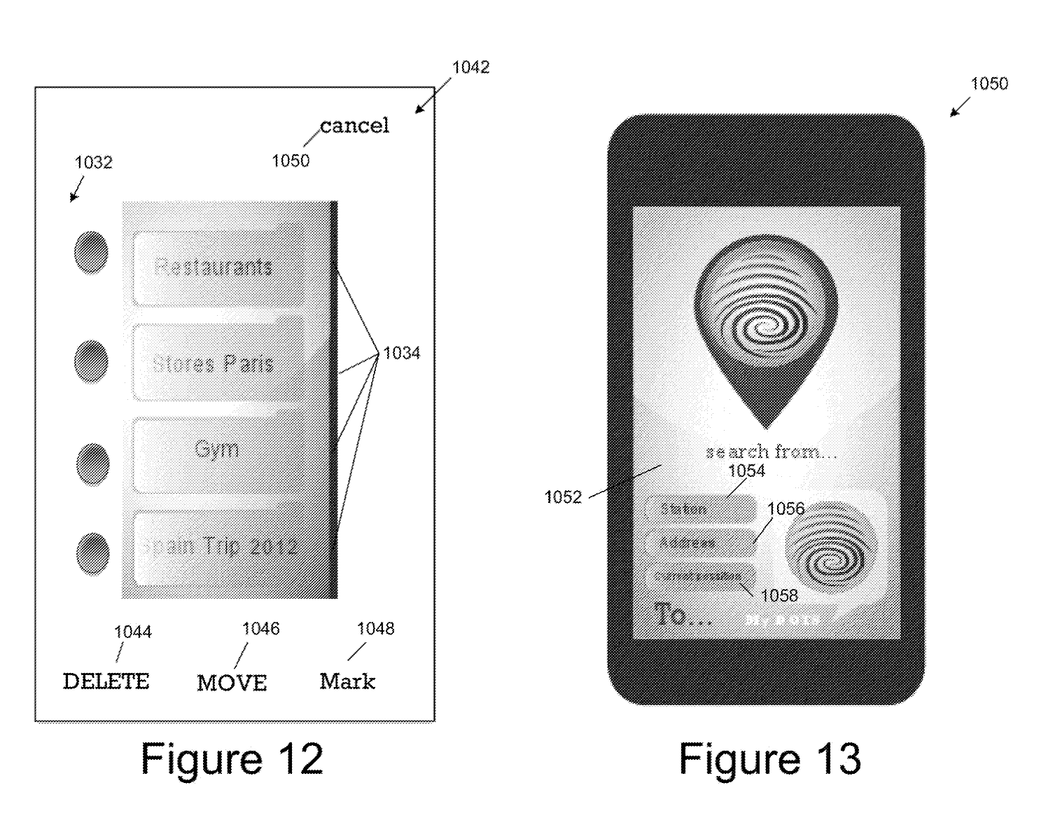

FIG. 12 is a screen shot illustrating one embodiment of an alternate interface screen 1042 showing an example hierarchal organization system for organizing place markers. The screen 1042 comprises folders 1034 with selection fields 1032, as described herein above. The screen also comprises Delete button 1044. For example, a user may select a folder 1034, subcategory, or place marker (not shown in FIG. 12) and delete the selected item by selecting the Delete button 1044. A Move button 1046 may allow the user to move categories, subcategories and/or place markers between locations within the hierarchy. A Mark button 1048 may allow the user to mark or notate a category, subcategory or place marker. In some embodiments, the app 206 associates one or more user-selected tags with one or more place markers. For example, the app 206 may associate a tag or tags with various place markers indicating categories and/or subcategories to which the place marker has been assigned by the user. When a particular place marker is shared with other users, tags may also be shared.

FIG. 13 is a screen shot illustrating one embodiment of an interface screen 1050 that may be displayed to a user to provide functionality for searching place markers. For example, the screen 1050 may be provided to a user to implement the place marker retrieval and/or search described above with respect to the process flows 500, 600. For example, in some embodiments where the screen 1050 is utilized in conjunction with the process flow 500, the screen 1050 is displayed to the user after the user has selected a particular place marker.

The screen 1050, as illustrated, comprises a start point field 1052 for receiving from the user a start point for use in conjunction with the search. The start point field 1052 may comprise various buttons 1054, 1056, 1058 indicating different allowable start points. A Station button 1054 may set the start point to a train station, subway station, bus stop, or other mass transit station. Selecting the button 1054 may set the start point to the nearest mass transit station and/or may cause the app 206 to provide the user with an indication of stations (e.g., a list or map) from which the user may select a station to be the start point. An Address button 1056 may set the start point to an address. For example, upon selection of the Address button 1056, the app 206 may prompt the user for the address. A Current Position button 1058 may set the start point to the current position of the user (e.g., the current position of the mobile computing device 102). For example, the mobile computing device 102 may determine the current location of the mobile computing device 102 utilizing the positioning module 322 of the mobile computing device 102.

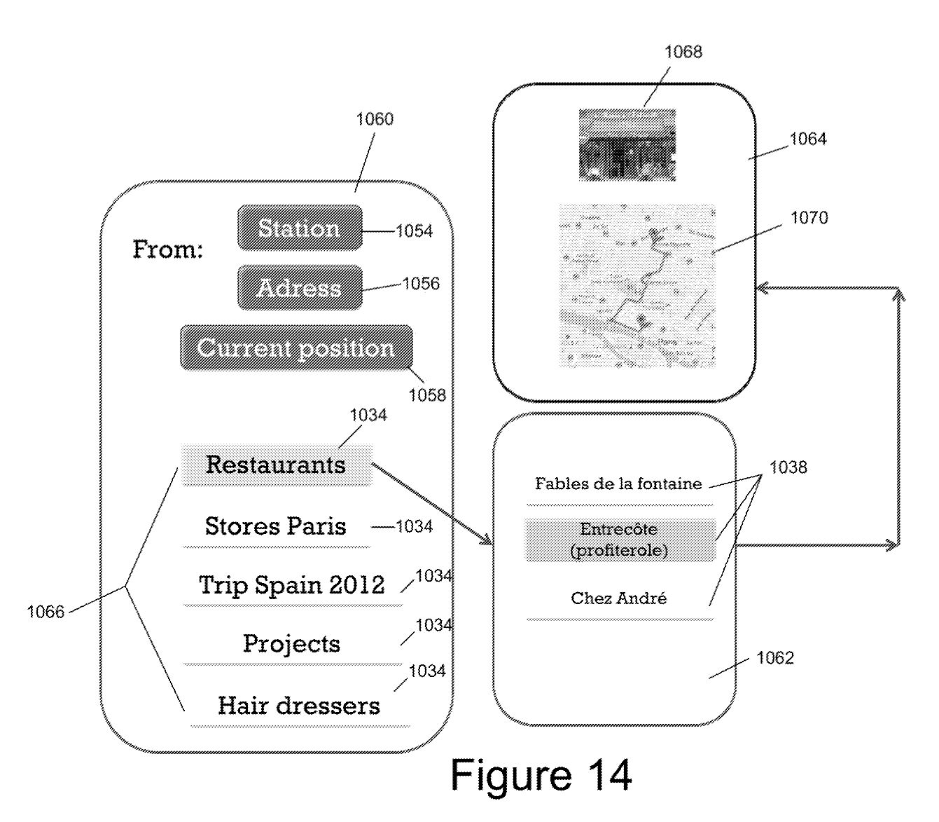

FIG. 14 shows several screen shots illustrating embodiments of interface screens 1060, 1062, 1064 that may be utilized to receive search parameters and display results of searches for place markers. Screen 1060 comprises the buttons 1054, 1056, 1058 described above with respect to screen 1050. For example, in some embodiments, the screen 1060 is provided by the app 206 instead of the screen 1050. Also, in some embodiments, the screen 1060 is provided by the app 206 when the user clicks through the screen 1050 without indicating a start point. Screen 1060 also comprises a place marker organization field 1066. For example, the user may provide categories and/or subcategories of place markers that may serve as search parameters. In some embodiments, additional search parameters, such as key words, may be provided, as described herein. Also, in some embodiments, the user may select more than one category, subcategory, etc. as a search parameter. It will be appreciated that when a user selects a category 1034 comprising multiple subcategories, the app 206 may additionally provide the user with an opportunity to select one or more of the subcategories as a search parameter.

Screen 1062 includes selectable fields indicating place markers 1038 meeting the entered search parameters. For example, the screen 1062 comprises place markers 1038 categorized under the category 1034 “Restaurants.” In some embodiments, the place markers 1038 are ordered within the screen 1062 according to increasing and/or decreasing distance between the places associated with the respective place markers and the start point, selected as described above. For example, the screen 1062 may correspond to the action 610 described above with respect to the process flow 600. When the user selects a place marker 1038 from the screen 1062, the app 206 may display the screen 1064. Screen 1064 comprises an information field 1068 and a map field 1070. The information field 1068 may comprise information about the selected place marker (e.g. information associated with the place). Such information may include, for example, text, images, other multi-media, etc., for example, as described above. The map field 1070 may comprise directions from the start point to the place associated with the selected place marker. The map field 1070 may display the directions in map form, as illustrated. In various embodiments, the map field 1070, upon selection by the user, may display textual indications of the directions. Also, in some embodiments, the map field 1070 may be associated with direction functionality of the mobile computing device 102. For example, the mobile computing device 102 may act through the map field 1070 to provide turn-by-turn directions to the user as the user travels to the place associated with the selected place marker. In some embodiments, the app 206 launches an additional, independent direction application upon selection of the map field 1070.

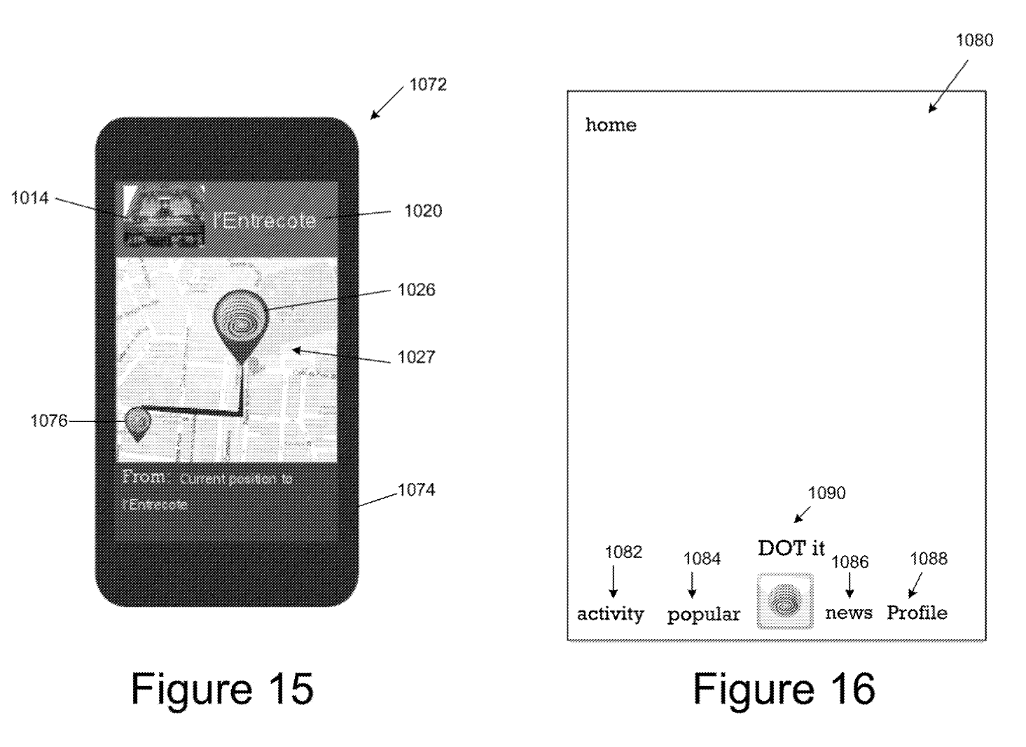

FIG. 15 is a screen shot illustrating one embodiment of an alternate interface screen 1072 for presenting directions to a place associated with a place marker. For example, the screen 1072 may be presented by the app 206 to the user instead of or in addition to the screen 1064. The screen 1072 is organized in a manner similar to that of the screen 1012 described above. For example, a field 1020 comprises text and a field 1014 comprises one or more images relating to the place marker or associated place. A start point field 1074 may list the start point selected, as described above. The map field 1026 described above, may provide directions from the start point (indicated by icon 1076) to the place associated with the selected place marker (indicated by icon 1026. The app 206 may provide functionality through the field 1026 similar to that described above with respect to the field 1070.

In various embodiments, the app 206 may comprise social functionality for allowing the user to share place markers and view place markers created and shared by other users. For example, in some embodiments, each user of the app 206 may have an account comprising information describing the user that may be utilized during the sharing process. FIGS. 16-22 are screen shots of interface screens illustrating various social functionality that the app 206 and/or app server 104 may provide to users. FIG. 16 is a screen shot illustrating one embodiment of a social menu interface screen 1080 that may be displayed by the app 206. The screen 1080 may be a home page shown to the user, for example, when the user launches the app 206 and/or logs-in to the app server 104 via the app 206. The screen 1080 comprises various buttons for navigating the app. For example, when the “DOT it” button 1090 is selected by the user, the app 206 may launch the functionality described above for creating, searching, and or viewing place markers. The Activity 1082, Explore 1084, News, 1086, and Profile 1088 buttons may provide various social functionality, as described herein.

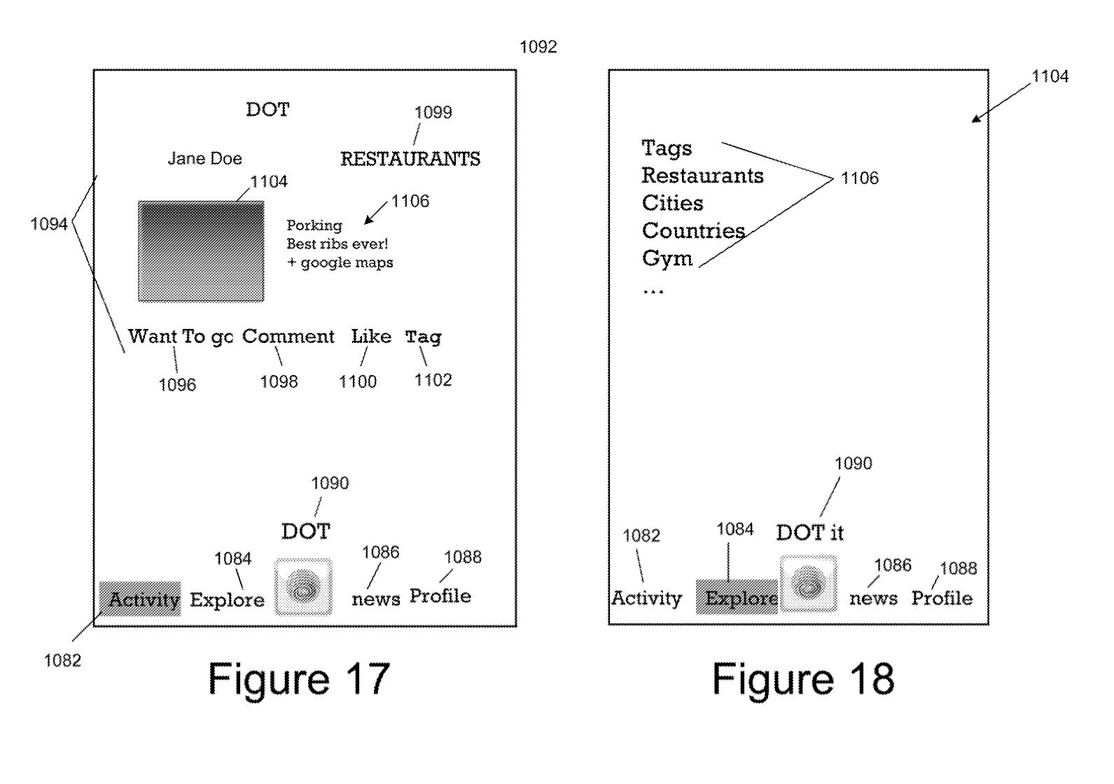

FIG. 17 is a screen shot showing one embodiment of an interface screen 1092 that may be displayed by the app 206 when the user selects, the Activity button 1082 of FIG. 16. The screen 1092 may display recent app 206 related activities of other users associated with the user. The other users may include users whose activities the user follows, users who follow the user's own activities, etc. As illustrated in FIG. 17, the screen 1092 shows a place marker 1094 recently entered by another user, “Jane Doe,” that is associated with the user. The place marker is described by an image field 1104 and a text field 1106 displaying images and/or text describing the place associated with the place marker. A category field 1099 may indicate a category or other tag applied to the place marker (e.g., by the creating user).

The place marker 1094 may also be associated with various buttons 1096, 1098, 1100, 1102, allowing the user to perform various actions with respect to the place marker. When the user selects the “Want To Go” button 1096, the app 206 may add the place marker to a list of place markers in which the user has indicated interest (e.g., interest in going to the associated place). The list of place markers may be stored at the mobile computing device 102 and/or app server 104 for the user. When the user selects the Comment button 1098, the app 206 may provide functionality for receiving from the user a comment on the place marker. The comment may be private, public, or public only to a selected user or users. For example, the comment may be stored at the mobile computing device 102, the application server 104 and/or may be transmitted directly or via the application server 104 to a mobile computing device 102 associated with the creating user (e.g., “Jane Doe”). When the user selects a “Like” button 1100, the app 206 may send a like indication to the app server 104. The like indication may increment a number of likes associated with the place marker 1094. For example, the number of likes associated with a place marker may be a search parameter, as described herein. An optional “Tag” button 1102, when selected by the user, may provide the user with functionality for tagging the place marker 1094. Tags provided via the screen 1092 may be transmitted to the app server 104 for storage in association with the place marker 1094.

FIG. 18 is a screen shot illustrating one embodiment of an interface screen 1104 that may be displayed by the app 206 when the user selects the explore button 1084 of FIG. 16. FIG. 18 illustrates icons 1106 that indicate popular functions of the app 206 that the user may access. For example, a Tags item 1106, when selected by the user, may allow the user to view tags that have been recently added to the users own place markers and/or shared place markers. Some items 1106, such as “Restaurants” and “Gym” may be popular categories and/or other search parameters describing recently created, viewed, and/or searched for place markers. Other items 1106, such as “Cities” and “Countries,” may indicate political or other geographic entities containing popular places associated with recently created, viewed and/or searched for place markers.

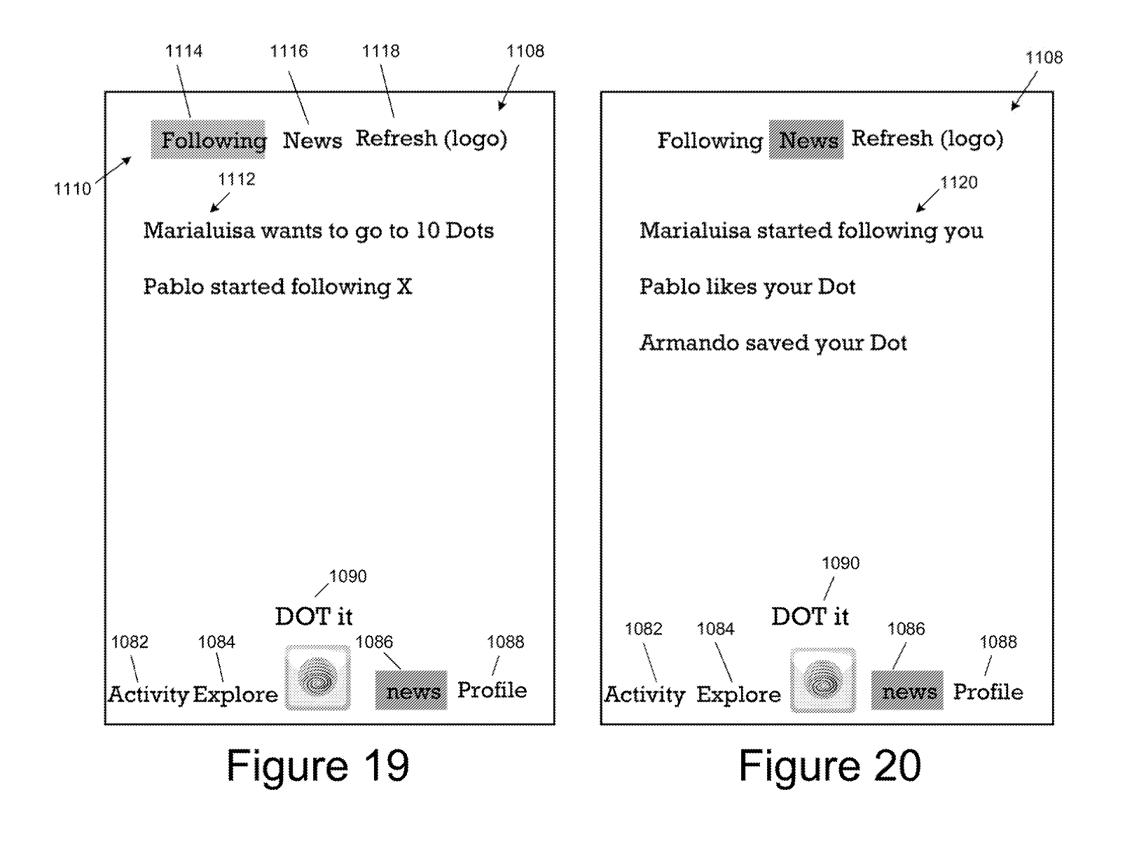

FIG. 19 is a screen shot illustrating one embodiment of an interface screen 1108 that may be displayed by the app 206 when the user selects the News button 1086 of FIG. 16 and a “Following” button 1114 of a button field 1110. The screen 1108 may be displayed by the app 206 to provide the user with information about other users that follow the user and/or are followed by the user. For example, when the “Following” button 1114 is selected, as shown in FIG. 19, a following field 1112 may provide the user with information about other users that the user follows. Such information may describe, for example, actions recently taken by the followed users with respect to place markers, including, for example, creation of a place marker, liking of a place marker, tagging of a place marker, indicating “want to go” with respect to a place marker, commenting on a place marker, etc. In some embodiments, the following field 1112 may also indicate actions taken by followed users with respect to other users (e.g., User A started following User B). A “Refresh” button 1118 may be selected by the user to updated the following field 1112 to include new items.

FIG. 20 is a screen shot illustrating one embodiment of an interface screen 1108 that may be displayed by the app 206 when the user selects the News button 1086 of FIG. 16 and a News button 1114 of a button field 1110. The screen 1108 comprises a news field 1120. The news field 1120 may display actions taken by other users that are followers of the user (e.g., follower users). Such actions may include, for example, initiating following of the user, liking a place marker generated by the user, tagging a place marker generated by the user, saving a place marker generated by the user (e.g., to a local mobile computing device 102 of the following user), indicating “want to go” with respect to a place marker generated by the user, commenting on a place marker generated by the user, etc.

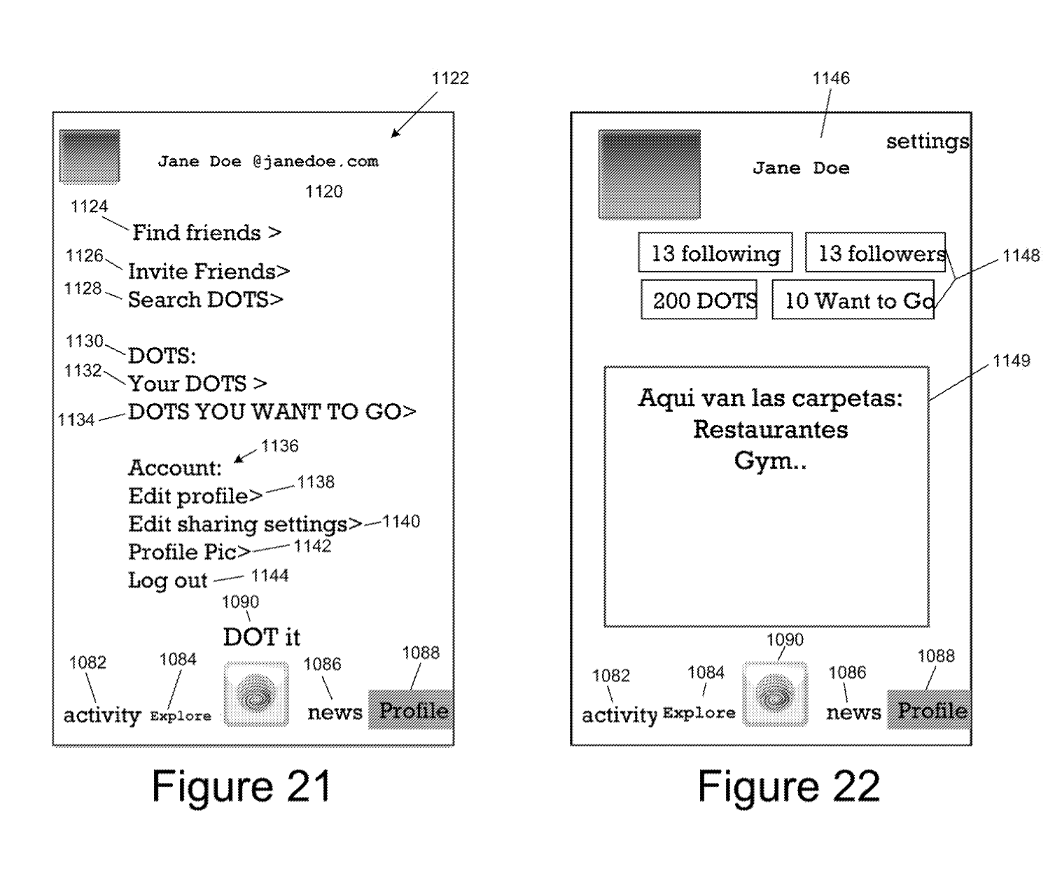

FIG. 21 is a screen shot illustrating one embodiment of an interface screen 1108 that may be displayed by the app 206 when the user selects the Profile button 1088. The screen 1108 may comprise various action buttons 1124, 1126, 1128 that allow the user to prompt the app 206 to perform various social-related actions. When the user selects a Find friends button 1124, the app 206 may implement functionality allowing the user to search for other users that the user may follow. For example, the app 206 may support various searches of users available for following (e.g., keyword searches, geographic searches, etc.). An Invite Friends button 1126 may be selected to allow the user to invite other users to follow the user. Similar searches of available users may be provided. (Whether a user is available to be followed or to follow another user may be indicated in the users sharing settings, described herein below.) A Search DOTS button 1128 may be selected to launch a search for place markers, for example, as described herein above with respect to process flows 500-600 and FIGS. 13-15.

A DOTS field 1130 may provide the user with functionality for viewing, retrieving and/or managing place markers (referred to in FIG. 21 as “DOTS”). When the user selects a Your DOTS button 1132, the app 206 may display to the user a set of place markers. The set of place markers may comprise place markers that were created by the user as well as place markers that the user is authorized to view (e.g., place markers that are shared with all users, place markers that are shared specifically with the user, place markers shared by other users that the user follows, etc.). In some embodiments, selecting the Your DOTS button 1132 may cause the app 206 to display the screen 1030 shown in FIGS. 10 and 11 and/or screen 1060 shown in FIG. 14, etc. When the user selects a Dots You Want To Go To button 1132, the app 206 may display to the user a list or other indication of place markers that the user has previously indicated an interest in (e.g., marked as Want To Go).

Account field 1136 is shown to comprise various functionality for managing the user's account settings. Selecting the Edit profile button 1138 may cause the app 206 to receive from the user account information (e.g., user name, password, e-mail address, phone number, physical address, etc.), or changes thereto. When the user selects an Edit sharing settings button 1140, the app 206 may receive from the user settings describing how place markers generated by the user are to be saved. In some embodiments, the user may indicate that all place markers generated by the user are to be shared. Also, in some embodiments, the user may indicate that the sharing of place markers should be based on categories, sub-categories, tags, or other characteristics of place markers. For example, the user may indicate that place markers having one characteristics or a set of characteristics are to be shared. In some embodiments, the user may indicate that all place markers, or place markers having specified characteristics should be shared only after prompting the user on creation of the place marker.

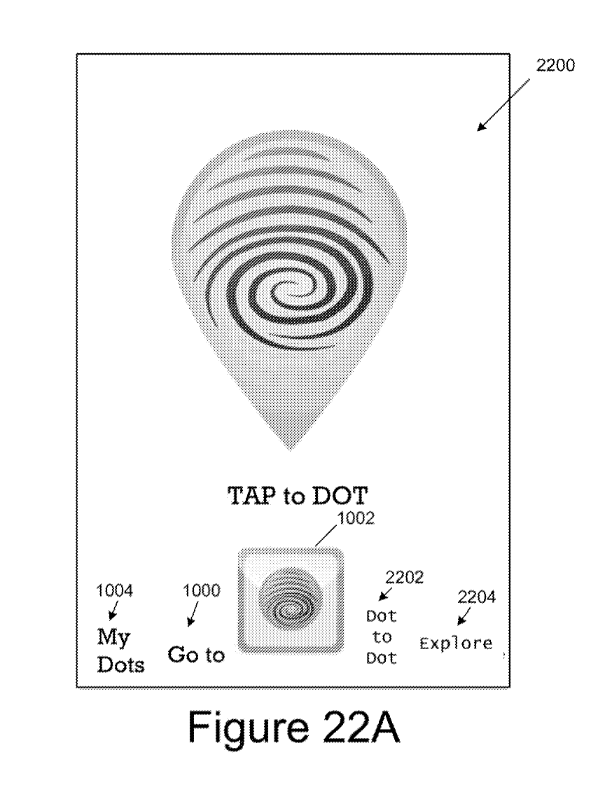

When the user selects an optional Profile Pic button 1142, the app 206 may be configured to receive an image or picture associated with the user's account. For example, the image may be displayed to other users who follow the user and/or receive shared place markers created by the user. When the user selects a Log out button 1144, the app 206 may log-out of the user's account. FIG. 22 is a screen shot showing one embodiment of an additional interface screen 1146 that may be displayed by the app when the user selects the Profile button 1088. The screen 1146 may comprise a status field 1148 showing various data regarding the user's account. For example, the status field 1148 may indicate a number of other users that the user follows, a number of other users following the user, a number of place markers (DOTS) that the user has created and/or is authorized to view, and a number of place markers that the user has indicate interest in (e.g., a number of Want To Go's). A place marker field 1149 may list categories of place markers that have either been created by the user and/or available to the user (e.g., shared place markers created by other users). The field 1149 may operate in a manner similar to that described above with respect to the screen 1030 in FIGS. 10 and 11.

FIG. 22A is a screen shot illustrating one embodiment of an interface screen 2200 that may be displayed to the user by the app 206, as described herein, to provide functionality for generating, searching, and viewing place markers. The screen 2200 comprises a button 1002, a My Dots button 1004, and a Go to button 1006 similar to those described above with respect to the screen 1000 of FIG. 7. Additionally, the screen comprises a Dot to Dot button 2202. The Dot to Dot button 2202 may provide the user with functionality to send and receive notifications. For example, selecting the Dot to Dot button 2202 may cause the app 206 to provide the user with functionality for generating and/or responding to a request for access to a shared folder or place marker. Selecting an Explore button 2202 may cause the app 206 to provide the user with various functionality for searching for place markers. For example, upon selection of the Explore button 2202, the app 206 may provide the user with functionality for viewing nearby and/or world wide personal or shared place markers. In some embodiments, the shared place markers may be filtered to show only those of followers of or users followed by the user.

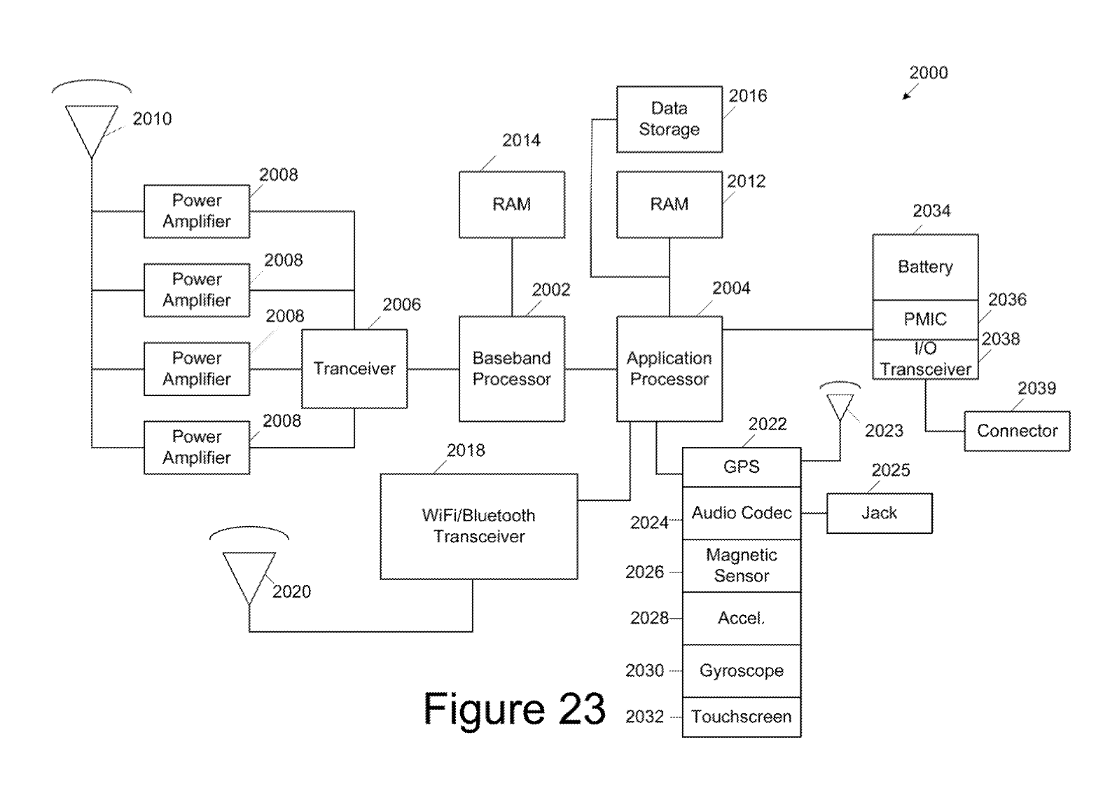

Having thus described various novel features of the app 206, additional details of example hardware and software architectures for the mobile computing device 102 are provide below. For example, FIG. 23 is a system diagram of one embodiment of an example architecture 2000 for the mobile computing device 102. The example architecture 2000 is similar to that of the iPHONE 4 available from APPLE, INC. The architecture 2000 may comprise multiple processors 2002, 2004. A baseband processor 2002 may handle communication over a mobile telecommunications network. The baseband processor 2002 may comprise dedicated random access memory (RAM) 2014. In various embodiments, the baseband processor 2002 may be in communication with a transceiver 2006. The transceiver 2006 may, subsequently, be in communications with one or more power amplifiers 2008 and an antenna 2010. Outgoing signals may be processed at baseband by the baseband processor 2002 and provided to the transceiver 2006. The transceiver 2006 and/or the baseband processor 2006 may modulate the outgoing signal to a carrier frequency. One or more of the amplifiers 2008 may amplify the outgoing signal, which may be subsequently transmitted via antenna 2010. Incoming signals may be received by the antenna 2010, amplified by one or more of the amplifiers 2008 and provided to the transceiver 2006. Either the transceiver 2006 or the baseband processor 2002 may demodulate the incoming signal to baseband.

An applications processor 2004 may execute an operating system (as described herein below) as well as applications or apps, such as the app 2006. In various embodiments, the applications processor 2004 may be from the APPLE A4 line of processors. The applications processor 2004 may be in communications with applications RAM 2012, and non-volatile data storage 2016. The applications processor 2004 may additionally be in communication with other hardware devices such as a combination WI-FI/BLUETOOTH transceiver 2018. The WI-FI/BLUETOOTH transceiver 2018 may handle radio frequency (RF) communication with a LAN (e.g., according to the WI-FI standard, or any suitable standard) or direct RF communications between the device 2000 and another wireless device (e.g., according to the BLUETOOTH standard or any suitable standard). A global positioning system (GPS) 2022 may be in communication with a satellite-based GPS system via a GPS antenna 2023 and provides the application processor 2004 with information describing the geographic location of the device 2000. A touch screen 2032 may both provide output to the user of the device 2004 in visual form and receive input from the user. The input may be in the form of signals representing screen-touches by the user. An audio codec module 2024 may provide hardware and/or software for decoding and playing audio signals. In some embodiments, the codec 2024 may also comprise a digital-to-analog converter. Audio output signals may be provided to a jack 2025, which may receive a set of headphones and/or speakers for playing the audio output signal.

Various other sensors may be included. A magnetic sensor 2026 may sense magnetic fields near the device. For example, the magnetic sensor 2026 may be used by various apps and/or system functionality to implement a compass. An accelerometer 2028 and gyroscope 2030 may provide data describing movement of the device. For example, data from the accelerometer 2028 and gyroscope 2030 may be used by some apps in a manner allowing movement of the device itself to be used as a controlled input to the app (e.g., similar to a mouse or joystick). In some embodiments, data from the accelerometer 2028 and gyroscope 2030 may be utilized to track the geographic location of the device, for example, in the course of generating retrieving and/or searching for place markers. Of course, data received from the gyroscope 2030 and accelerometer 2038 may be used for various other purposes as well, depending on the app. The architecture 2000 may be powered by a battery 2034, which may, in turn, be managed by a power management integrated circuit (PMIC) 2036. An I/O transceiver 2038 may manage wired communications between the device and other devices, for example, according to the Universal Serial Bus (USB) or any other suitable standard. A connector 2039 may facilitate wired connections. In some embodiments, connections via the connector 2039 and I/O transceiver 2038 may provide power for charging the battery 2034.

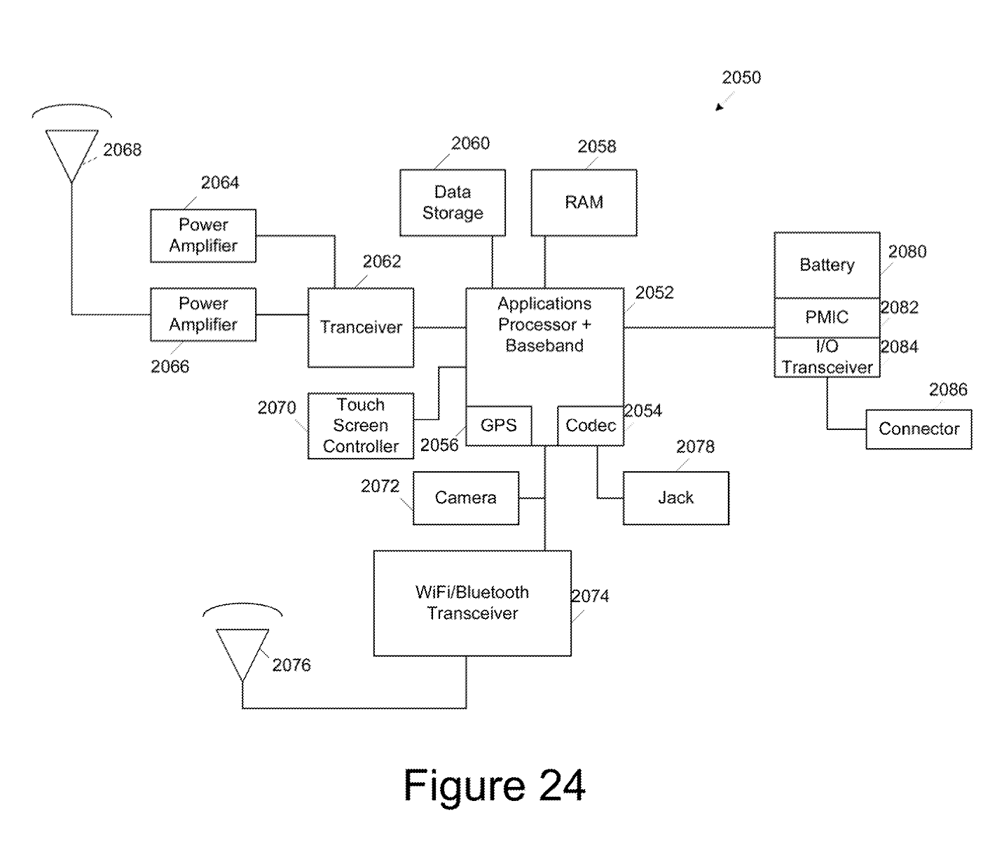

FIG. 24 is a system diagram of another embodiment of an example architecture 2050 for the mobile computing device. For example, the architecture 2050 is similar to that of the DROID INCREDIBLE available from HTC CORP. A single processor 2052 may handle applications processing as well as baseband processing for mobile telecommunications. The processor 2052 may also comprise an onboard GPS module 2056 and audio codec 2054. The audio codec 2054 may be in communication with an audio jack 2078 for receiving a connection to a set of headphones and/or speakers. In various embodiments, the processor 2052 may be a model QSD8650 available from QUALCOMM, INC. The processor 2052 may also be in communication with RAM 2058 and data storage 2060, which may be utilized for various processing tasks. A touch screen controller 2070 may provide a functional interface between the processor 2052 and a touch screen display of the device.

A camera 2072 in communication with the processor 2052 may comprise appropriate hardware and/or software for providing images and/or video to the processor 2052. WI-FI/BLUETOOTH transceiver 2074 may provide LAN and/or device specific wireless communications, utilizing antenna 2076. Transceiver 2062, power amplifiers 2064, 2066 and antenna 2068 may be utilized to provide mobile telecommunications, for example, in a manner similar to that described above with respect to the architecture 2000. Power may be provided to the architecture by a battery 2080 and PMIC 2084. An I/O transceiver 2084 may manage wired connections between the device and other devices (e.g., via a connector 2086). The I/O transceiver 2084 and connector 2086 may aid in charging of the battery 2080, for example, in a manner similar to that of the architecture 2000 described above. It will be appreciated that the architectures 2000 and 2050 are provided for example purposes only. Mobile computing devices for executing the apps here may be of any suitable architecture. For example, the mobile computing device 102, described herein above, may be constructed according to the architecture 2000, the architecture 2050, or any other suitable architecture. For example, in some embodiments, the mobile computing device 102 may omit telephony components (e.g., transceiver 2006, 2062 and related components).

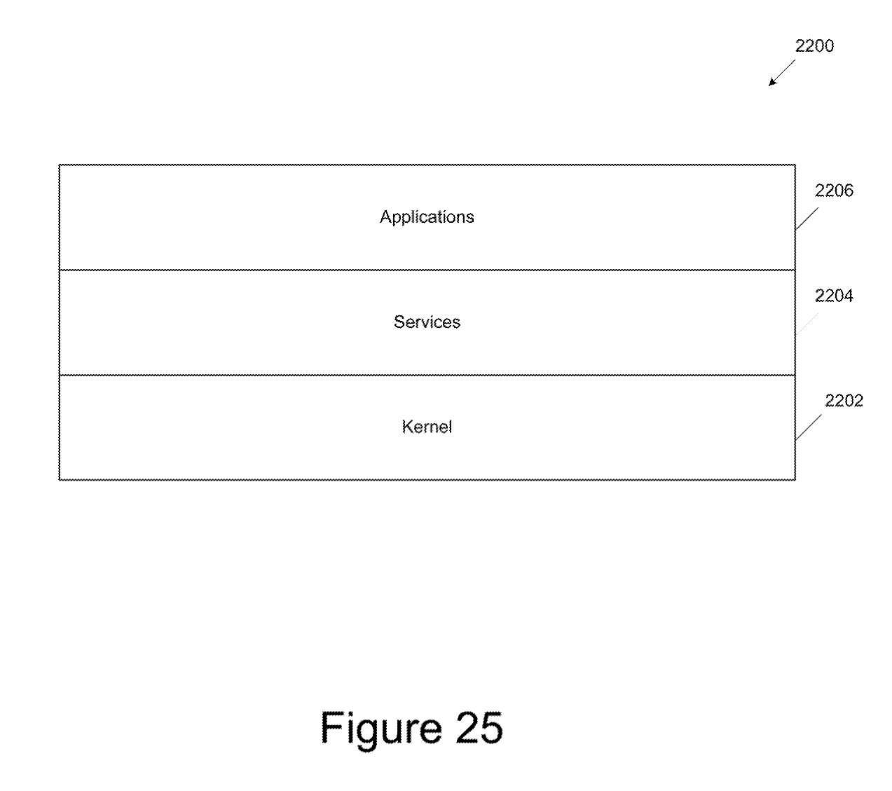

According to most architectures, the mobile computing device 102 executes an operating system that manages the execution of apps and provide apps with access to the various hardware and/or software modules and features of the device 102. FIG. 25 is a diagram of one embodiment of an example operating system 2200 for the mobile computing device 102. The operating system 2200 may be any suitable operating system including, for example, SYMBIAN available from ACCENTURE, POS available from APPLE, INC., WINDOWS MOBILE available from MICROSOFT CORPORATION, ANDROID available from GOOGLE, INC., etc. Some mobile computing devices 102 may execute operating systems that are not specifically designed for mobile computing devices such as, for example, MAC OS X available from APPLE, INC., any WINDOWS operating system available from MICROSOFT CORPORATION, LINUX, UNIX, etc.

The operating system 2200 may generally comprise a core or kernel layer 2202, a services layer 2204 and an applications layer 2206. The kernel layer 2202 may execute and/or manage low-level operations of the mobile computing device 102. For example, in some embodiments, the kernel layer 2202 may implement hardware drivers to handle low-level interactions with different hardware components such as, for example, the camera 320, positioning module 322, sensors 324, memory 304, data storage, 306, 326, communications port 316, etc. For example, the kernel layer 2202 may implement memory allocation and/or management including deriving and transmitting appropriate low-level commands for reading and writing to memory. The kernel layer 2202 may also comprise functionality for managing data storage, such as the data storage 306 and removable memory 326, etc. For example, the kernel layer 2202 may implement and/or interface with one or more file systems and may format read and write requests according to the file system or systems for each respective data storage device 306, 326. The kernel layer 2202 may also handle low-level aspects of communication between the device 102 and other computing devices (e.g., via the LAN communications module 314, communications port 316, mobile telecommunications module 312, etc.). In some embodiments, the kernel layer 2202 may also handle security aspects of communications. For example, the kernel layer 2202 may implement encryption (e.g., symmetric or asymmetric encryption) in a manner that is transparent to higher levels of the operating system 2200. In various embodiments, the kernel layer 2202 may additionally perform various processing tasks such as, for example, some types of calculation/computation (e.g., linear algebra, signal processing tasks, media manipulation tasks, etc.).

The services layer 2204 of the operating system 2200 may provide an interface between the functionality of the kernel layer 2202 and apps executing at the applications layer 2206, allowing the apps to access kernel layer functionality. For example, the services layer 2204 may comprise one or more libraries of commands and/or functions that may be called by apps to access kernel layer functionality (e.g., read and write commands, communication commands, etc.). Also, in some cases, the services layer 2204 may execute intermediate level functionality such as, for example, media players, activity monitoring, event notification, etc.

The applications layer 2206 may host applications or apps executed by the device 102 including, for example, the app 206. Many apps implement a direct user interface to a user of the device 102. Apps may be third party apps and/or core apps associated with (and sometimes shipped with) the operating system. Example third party apps may provide place marker functionality, for example, as described herein. Examples of core apps shipped with the ANDROID operating system include a short message service (SMS) app, a calendar app, a map app, a contacts app, an Internet browser app, etc. It will be appreciated that the mobile computing device 102 may execute any suitable operating system, and that some operating systems may have structures slightly or even considerably different than that of the operating system 2200 described above.

Various activities of the mobile computing device 102 described herein may be facilitated by an operating system architecture, such as 2200. For example, in the various situations described herein where the mobile computing device 102 derives its own location, it may determine available location-functionality and query the available location functionality. Determining the available location systems of the mobile computing device 102 and querying the systems may comprise the app 206 (e.g., executing at an applications layer 2206) utilizing an application programming interface (API) provided by the services layer 2204 to access the kernel or other low-level features of the location system(s), such as various hardware implementations of the positioning module 322 (e.g., GPS 2022, GPS 2056, etc.). Also, communications between the app 206 and the app server 104 may be facilitated by the operating system 2200. For example, the app 206 (e.g., executing at the applications layer 2206) may utilize the API of the services layer 2204 to access various hardware implementations of the mobile telecom module 312 and/or LAN telecom module 314 (e.g., transceiver 2062, transceiver 2006, etc.).

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, methods or processing structures described herein are necessarily intended to limit the scope of the invention.

Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices. It should be borne in mind, however, that all of these and similar terms are to be associated with the appropriate physical quantities and are merely convenient labels applied to these quantities.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused descriptions would not facilitate a better understanding of the present invention, and therefore, a more detailed description of such elements is not provided herein.

In various embodiments, modules or software can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention.

Moreover, the processes associated with the present embodiments may be executed by programmable equipment, such as computers. Software or other sets of instructions may be employed to cause programmable equipment to execute the processes. The processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

A “computer,” “computer system,” “computing device,” “host,” “engine,” or “processor” may be, for example and without limitation, a processor, microcomputer, minicomputer, server, mainframe, laptop, personal data assistant (PDA), wireless e-mail device, cellular phone, pager, processor, fax machine, scanner, tablet computer or any other programmable device configured to transmit and/or receive data over a network. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

Various embodiments of the systems and methods described herein may employ one or more electronic computer data networks to promote communication among different components, transfer data, or to share resources and information. Such computer networks can be classified according to the hardware and software technology that is used to interconnect the devices in the network, such as optical fiber, Ethernet, wireless LAN, HomePNA, power line communication or G.hn. The computer networks may also be embodied as one or more of the following types of networks: local area network (LAN); metropolitan area network (MAN); wide area network (WAN); virtual private network (VPN); storage area network (SAN); or global area network (GAN), among other network varieties.

For example, a WAN computer network may cover a broad area by linking communications across metropolitan, regional, or national boundaries. The network may use routers and/or public communication links One type of data communication network may cover a relatively broad neighborhood (e.g., city-to-city or country-to-country) which uses transmission facilities provided by common carriers, such as telephone service providers. In another example, a GAN computer network may support mobile communications across multiple wireless LANs or satellite networks. In another example, a VPN computer network may include links between nodes carried by open connections or virtual circuits in another network (e.g., the Internet) instead of by physical wires. The link-layer protocols of the VPN can be tunneled through the other network. One VPN application can promote secure communications through the Internet. The VPN can also be used to separately and securely conduct the traffic of different user communities over an underlying network. The VPN may provide users with the virtual experience of accessing the network through an IP address location other than the actual IP address which connects the access device to the network.

Computer networks may include hardware elements to interconnect network nodes, such as network interface cards (NICs) or Ethernet cards, repeaters, bridges, hubs, switches, routers, and other like components. Such elements may be physically wired for communication and/or data connections may be provided with microwave links (e.g., IEEE 802.12) or fiber optics, for example. A network card, network adapter or NIC can be designed to allow computers to communicate over the computer network by providing physical access to a network and an addressing system through the use of MAC addresses, for example. A repeater can be embodied as an electronic device that receives and retransmits a communicated signal at a boosted power level to allow the signal to cover a telecommunication distance with reduced degradation. A network bridge can be configured to connect multiple network segments at the data link layer of a computer network while learning which addresses can be reached through which specific ports of the network. In the network, the bridge may associate a port with an address and then send traffic for that address only to that port. In various embodiments, local bridges may be employed to directly connect local area networks (LANs); remote bridges can be used to create a wide area network (WAN) link between LANs; and/or, wireless bridges can be used to connect LANs and/or to connect remote stations to LANs.

In various embodiments, a hub may be employed which contains multiple ports. For example, when a data packet arrives at one port of a hub, the packet can be copied unmodified to all ports of the hub for transmission. A network switch or other devices that forward and filter OSI layer 2 datagrams between ports based on MAC addresses in data packets can also be used. A switch can possess multiple ports, such that most of the network is connected directly to the switch, or another switch that is in turn connected to a switch. The term “switch” can also include routers and bridges, as well as other devices that distribute data traffic by application content (e.g., a Web URL identifier). Switches may operate at one or more OSI model layers, including physical, data link, network, or transport (i.e., end-to-end). A device that operates simultaneously at more than one of these layers can be considered a multilayer switch. In certain embodiments, routers or other like networking devices may be used to forward data packets between networks using headers and forwarding tables to determine an optimum path through which to transmit the packets.

As employed herein, an application server, or application server system, may be a server that hosts an API to expose place marker logic and place marker processes for use by other applications. Examples of application server systems include J2EE or Java EE 5 application server systems including WebSphere Application Server. Other examples include WebSphere Application Server Community Edition (IBM), Sybase Enterprise Application Server (Sybase Inc), WebLogic Server (BEA), JBoss (Red Hat), JRun (Adobe Systems), Apache Geronimo (Apache Software Foundation), Oracle OC4J (Oracle Corporation), Sun Java System Application Server (Sun Microsystems), and SAP Netweaver AS (ABAP/Java). Also, application server systems may be provided in accordance with the .NET framework, including the Windows Communication Foundation, .NET Remoting, ADO.NET, and ASP.NET among several other components. For example, a Java Server Page (JSP) is a servlet that executes in a web container which is functionally equivalent to CGI scripts. JSPs can be used to create HTML pages by embedding references to the server logic within the page. The application server systems may mainly serve web-based applications, while other servers can perform as session initiation protocol servers, for instance, or work with telephony networks. Specifications for enterprise application integration and service-oriented architecture can be designed to connect many different computer network elements. Such specifications include Business Application Programming Interface, Web Services Interoperability, and Java EE Connector Architecture.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as set forth in the appended claims.

We claim:

1. A computer-implemented system for processing place markers at a mobile computing device, the system comprising:
a mobile computing device, the mobile computing device programmed to:
receive from a user of the mobile computing device a request to generate a first place marker for a first place corresponding to a current location of the mobile computing device;
receive an indication of the current location of the mobile computing device;
receive descriptive information associated with the first place;
generate the first place marker, wherein the first place marker comprises an indication of a location of the first place and the user information associated with the first place, wherein the location of the place is the current location of the mobile computing device.

2. The system of claim 1, wherein receiving the indication of the current location of the mobile computing device comprises querying a positioning module of the mobile computing device.

3. The system of claim 1, wherein the descriptive information associated with the first place comprises an image of at least a portion of the first place.

4. The system of claim 3, wherein the mobile computing device is further programmed to capture the image of at least the portion of the first place utilizing a camera of the mobile computing device.

5. The system of claim 1, wherein the descriptive information associated with the first place comprises text received from the user.

6. The system of claim 1, wherein the mobile computing device is further programmed to:
determine whether the first place marker is authorized to be shared with other users;
conditioned upon the first place marker being authorized to be shared with other users, transmitting the first place marker to a remote server.

7. The system of claim 6, wherein transmitting the first place marker to the remote server comprises transmitting an indication of a selected group of users with whom the first place marker may be shared.

8. The system of claim 1, wherein the mobile computing device is further programmed to:
receive, from the user, a request to retrieve the first place marker;
request from a geographic service server directions to the first place;
provide the directions to the first place to the user.

9. The system of claim 8, wherein the mobile computing device is further programmed to receive from the user a direction start point, wherein the directions to the first place requested from the geographic service server are from the start point.

10. The system of claim 1, wherein the mobile computing device is further programmed to:
receive from the user an indication of a folder associated with the first place marker;
instruct a remote server to make the folder visible to at least one other user.

11. The system of claim 10, wherein the mobile computing device is further programmed to:
receive a request to view at least one place marker in the folder, wherein the request originates from a second user selected from the at least one other user and wherein the at least one place marker in the folder comprises the first place marker;
prompt the user to authorize the request.

12. A computer-implemented method for processing place markers at a mobile computing device, the method comprising:
receiving, by the mobile computing device and from a user of the mobile computing device, a request to generate a first place marker for a first place corresponding to a current location of the mobile computing device;
receiving, by the mobile computing device, an indication of the current location of the mobile computing device;
receiving, by the mobile computing device, descriptive information associated with the first place;
generating, by the mobile computing device, the first place marker, wherein the first place marker comprises an indication of a location of the first place and the user information associated with the first place, wherein the location of the place is the current location of the mobile computing device.

13. A computer-implemented system for processing place markers, the system comprising:
a mobile computing device, the mobile computing device programmed to:
receive from a user a place marker retrieval request;
receive from the user a start point;
receive from a geographic service server directions to a first place associated with a first place marker from the start point, wherein the first place marker comprises an indication of the first location and descriptive information associated with the first place;
display the directions to the user.

14. The system of claim 13, wherein the place marker retrieval request comprises an indication of the first place marker.

15. The system of claim 13, wherein the mobile computing device is further programmed to:
display to the user a plurality of place markers comprising the first place marker;
receive from the user an indication of the first place marker.

16. The system of claim 15, wherein displaying to the user the plurality of place markers comprises displaying the plurality of place markers according to a hierarchal organization system.

17. The system of claim 15, wherein the mobile computing device is further programmed to:
query a place marker database according to at least one search parameter;
receive as a response to the query an indication of the plurality of place markers.

18. The system of claim 17, wherein the at least one search parameter specifies a threshold distance from the start point and wherein the plurality of place markers are within the threshold distance of the start point.

19. The system of claim 17, wherein the at least one search parameter comprises at least one parameter received from the user.

20. The system of claim 17, wherein the place marker database comprises a local storage of the mobile computing device and at least one remote storage location.

21. The system of claim 15, wherein the plurality of place markers comprises at least one place marker generated by the user and at least one place marker not generated by the user.

22. The system of claim 15, wherein the mobile computing device is further programmed to transmit to a remote server a request to follow place markers generated by a second user and wherein the plurality of place markers comprises at least one place marker generated by the second user.

23. The system of claim 13, wherein the mobile computer device is further programmed to:
display to the user a plurality of shared folders;
receive from the user a request to access at least one place marker in a first folder selected from the plurality of shared folders;
conditioned upon the request being granted, display to the user the at least one place marker in the first folder, wherein the at least one place marker comprises the first place marker.

24. A computer-implemented method for processing place markers at a mobile computing device, the method comprising:
receiving, by the mobile computing device and from a user, a place marker retrieval request;
receiving, by the mobile computing device and from the user, a start point;
receiving, by the mobile computing device and from a geographic service server, directions to a first place associated with a first place marker from the start point, wherein the first place marker comprises an indication of the first location and descriptive information associated with the first place;
displaying, by the mobile computing device, the directions to the user.
